(19) United States
(12) Patent Application Publication
(10) Pub. No.: US 2026/0141738 A1
(43) Pub. Date: May 21, 2026

(54) COMPUTER IMPLEMENTED METHOD FOR TRAINING A MACHINE LEARNING MODEL FOR SEMANTIC IMAGE SEGMENTATION

(71) Applicant: Carl Zeiss AG, Oberkochen (DE)

(72) Inventors: Simon Reiss, Karlsruhe (DE); Alexander Freytag, Erfurt (DE); Rainer Stiefelhagen, Karlsruhe (DE); Constantin Seibold, Karlsruhe (DE)

(21) Appl. No.: 19/366,600

(22) Filed: Oct. 23, 2025

Related U.S. Application Data
(63) Continuation-in-part of application No. PCT/EP2024/063009, filed on May 11, 2024.

(30) Foreign Application Priority Data
May 11, 2023 (DE) 102023112553.2

(51) Int. Cl. G06V 20/70; G06V 10/764

(52) U.S. Cl. CPC G06V 20/70; G06V 10/764

(57) ABSTRACT

The invention relates to a computer implemented method for training a machine learning model for semantic image segmentation, the method comprising: obtaining training images collectively containing at least three different types of annotations, and training the machine learning model using a loss function, wherein the formulation of the loss function at at least one pixel depends on the types of annotations at the pixel and on the types of annotations within each batch. The invention also relates to a computer implemented method for semantic segmentation making use of the trained machine learning model, and to corresponding systems, computer programs and computer readable media.

### CROSS-REFERENCE TO RELATED APPLICATIONS

The present application is a continuation-in-part of and claims benefit under 35 U.S.C. § 120 from PCT patent application PCT/EP2024/063009, filed on May 11, 2024, which claims the priority of German patent application No. 10 2023 112 553.2, filed on May 11, 2023. The entire contents of the above applications are herein incorporated by reference.

### TECHNICAL FIELD

The invention relates to methods and systems for semantic image segmentation, for example medical images into tissue types. The techniques described herein may generally be applied to any imaging modality in any technical field, including without limitation, images acquired by a camera, scanning electron microscopy (SEM) images, focused ion beam scanning electron microscopy (FIB-SEM) images, magnetic resonance (MR) images, ultrasound images, and computed tomography (CT) images.

### BACKGROUND

Semantic image segmentation is a computer vision task in which the goal is to categorize each pixel in an image into a class. The goal is to produce a dense pixel-wise segmentation map of an image, where each pixel is assigned to a specific class.

Due to important advances in machine learning methods present semantic image segmentation approaches can be used in a wide range of application fields such as medical images, natural images or urban scenes. These advances were only possible due to the availability of large amounts of annotated training data for the machine learning methods. Crowd sourcing with briefly instructed annotators is a popular choice to obtain these amounts of annotated training data. However, for application fields requiring annotations of extensively trained expert annotators, such as biological or medical applications, crowd sourcing is not an option. Thus, obtaining sufficiently large amounts of annotated training data is difficult or even impossible in some application domains due to the limited availability of expert annotators. Efficiently using the available expert annotator resources is, thus, important during the annotation of training data.

In addition, it is a common belief that the accuracy of a trained machine learning model usually correlates with the specificity of the provided annotations. For example, image level annotations are less specific than bounding box annotations, and bounding box annotations are less specific than pixel wise annotations. Thus, if possible, training should be carried out with pixel wise annotations only to obtain accurate predictions. Yet, pixel wise annotations require a lot of time and effort by the expert annotator and are often not available. Here the question is whether the accuracy of the trained machine learning model truly correlates with the specificity of the available annotation types.

In the literature, different ways are known to reduce the amount of required annotations.

Machine learning approaches requiring only limited amounts of annotations are, for example, semi-supervised approaches. Semi-supervised approaches are designed to learn from large amounts of unannotated training data while requiring only a small number of annotated training data. One way for limiting the amount of required annotations is the generation of artificial annotations. In the field of image segmentation, for example, pseudo-labeling approaches are known. Pseudo-labeling leverages the idea of using the trained machine learning model itself to generate artificial labels, in particular hard labels (i.e., the argmax of the output of the machine learning model), for unannotated training images. The artificially generated annotations are used for training only if the largest probability for any of the labels lies above a predefined threshold.

A known example is called FixMatch, which was disclosed in “Kihyuk Sohn, David Berthelot, Nicholas Carlini, Zizhao Zhang, Han Zhang, Colin A Raffel, Ekin Dogus Cubuk, Alexey Kurakin, and Chun-Liang Li, FixMatch: Simplifying semi-supervised learning with consistency and confidence, Advances in neural information processing systems, vol. 33, pp. 596-608, 2020”. FixMatch generates pseudo-labels from weakly augmented training images as supervision signal for strongly augmented versions of the same training images.

However, pseudo-labeling approaches do not generate additional knowledge, but artificially extend the training data based on knowledge the machine learning model already gained. Thus, on the one hand, they require extensive training of the machine learning model before pseudo-labels can be reliably generated, and on the other hand the generation of incorrectly labeled training data cannot be prevented.

Another way to limit the required annotations is to use weakly annotated training data. Such weak annotations are specific types of annotations, which are simpler and faster to generate than fully annotated training images. They are called “weak” since they are less accurate, for example in terms of the pixels belonging to the annotated object, in terms of the exact location of the annotated object or in terms of the classes contained in a training image. For example, some weak annotation types do not contain all pixels belonging to an annotated object such as scribbles or point annotations. Other weak annotation types contain additional pixels which do not belong to the annotated object such as bounding boxes or image level annotations. Further weak annotation types contain only a subset of the objects or object instances in a training image such as partial annotations. Such weak annotations have been used for training machine learning models for image segmentation by formulating useful assumptions or priors that can be exploited during training. However, such assumptions often do not hold in expert level application domains.

A training algorithm for a machine learning model for semantic image segmentation using weak annotations in the form of image level annotations and bounding box annotations was disclosed in “Qizhu Li, Anurag Arnab, and Philip H S Torr. Weakly- and semi-supervised panoptic segmentation. In Proceedings of the European conference on computer vision (ECCV), pages 102-118, 2018.” This training algorithm does not use the weak annotations directly but transforms them into pixel level annotations using additional machine learning methods for segmentation, e.g., GrabCut for segmenting bounding box annotations, or heat maps obtained by training a convolutional neural network (CNN) for multi-label classification. Thus, in fact, this machine learning model still requires pixelwise annotations and depends on the accuracy of other machine learning models to obtain them.

In “Ye, Linwei; Liu, Zhi; Wang, Yang: Learning semantic segmentation with diverse supervision, Winter Conference on Applications of Computer Vision, 2018” a method for training a machine learning model for semantic segmentation is disclosed. The machine learning model uses a loss function that can handle three different annotation types. The formulation of the loss function in equation (5), however, does not depend at at least one pixel on the types of annotations at that pixel. First, the formulation of the loss function does not allow for different annotation types at a single pixel at all. Instead, each training image only contains a single annotation type. Thus, the loss function depends on the annotation type within an image but not on the annotation types at a single pixel. Hence, different loss terms at different pixels in the same training image cannot occur. The loss function is, thus, image-based instead of pixel-based. Second, the formulation of the loss function in equation (5) is fixed independent of the annotation type in a training image—only two of the three terms of the loss function evaluate to 0 depending on the annotation type. Apart from the pixel-based formulation of the loss function, the formulation of the loss function in equation (5) does not depend on the types of annotations within a batch, either, as the batch does not occur in the formulation of the loss function at all. Using only training images of a single annotation type within a batch is a question of how to select the training data but has no influence on the formulation of the loss function.

In “Shapolov, Roman et al., Multi-utility Learning: Structured-output Learning with Multiple Annotation-specific Loss Functions, in Energy Minimization Methods in Computer Vision and Pattern Recognition, 2015” a method for training a Structured Support Vector Machine (SSVM) with three different annotation types is disclosed. A different loss function is used for each annotation type. As the SSVM is not trained in a batch-wise manner, the formulation of the loss function does not depend on the types of annotations within a batch.

It is, therefore, an aspect of this invention to make training image annotation possible for expert level application domains. It is another aspect of the invention to simplify the annotation process for the expert. It is another aspect of the invention to optimally use the information contained in the specific annotation types to improve the accuracy of the predictions of the machine learning model. It is another aspect of the invention to allow for different annotation types to occur within the same image or at the same pixel. Another aspect of the invention is to reduce the time required by the expert for image annotation. It is another aspect of the invention to improve the accuracy of predictions of machine learning models for semantic image segmentation. In addition, an aspect of the invention is to reduce the amount of required training data for training machine learning models for semantic image segmentation and, thus, the effort of the expert. A further aspect of the invention is to make the annotation process more flexible.

### SUMMARY

Embodiments of the invention concern computer implemented methods for training a machine learning model for semantic image segmentation, computer implemented methods for semantic image segmentation, a data processing apparatus, a system for semantic image segmentation, a corresponding computer program and a corresponding computer-readable medium.

A first embodiment of the invention involves a computer implemented method for training a machine learning model for semantic image segmentation, the method comprising: obtaining training images collectively containing at least three different types of annotations, each annotation comprising one or more pixels of a training image and an indicated class label, the types of annotations being from a group comprising:
Complete pixel level annotations comprising all pixels of the training image that are assigned to the indicated class, in case the training image is fully labeled,
Positive partial pixel level annotations comprising a portion of the pixels of the training image that are assigned to the indicated class,
Subset level annotations comprising a subset of the training image, such that a portion of the pixels within the subset is assigned to the indicated class, and
Positive image level annotations comprising the training image, such that a portion of the pixels of the training image is assigned to the indicated class,
Negative partial pixel level annotations comprising a portion of the pixels of the training image that are not assigned to the indicated class,
Negative image level annotations comprising the training image, wherein none of the pixels of the training image is assigned to the indicated class.

The method further comprises training a machine learning model by iteratively presenting a batch of training images to the machine learning model and modifying the parameters of the machine learning model using a loss function, wherein the formulation of the loss function at at least one pixel depends on the types of annotations at the pixel and on the types of annotations within the batch, for the purpose of using the trained machine learning model for semantic image segmentation.

By allowing for various annotation types in the training images, the time required for annotation and training can be reduced, the flexibility of the annotation process is improved, the annotation effort is reduced, and the accuracy of the machine learning model is improved for the following reasons. The simultaneous use of multiple annotation types during training allows the annotation process to be tailored to the requirements of the specific application domain. Some application domains require more accurate annotations than others, e.g., defect detection applications in the semiconductor domain require highly accurate segmentations and, thus, highly accurate annotations, whereas, e.g., the extraction of objects from natural images requires less accurate segmentations and, thus, less accurate annotations. The simultaneous use of multiple annotation types during training also allows the annotation process to be tailored to the contents of each specific training image. Some training images may contain structures of interest, e.g., rare or multiple defects in semiconductor structures and, thus, require complete pixel level annotations or positive partial pixel level annotations, whereas some training images may contain no defects and, thus, be marked with a positive image level annotation, while again other training images may contain common defects or easily identifiable defects such that a subset level domain annotation is sufficient. The simultaneous use of multiple annotation types during training also increases the amount of training data available for the training of the machine learning model, since the available expert annotator resources can be used most efficiently. Finally, the use of different types of annotations increases the accuracy of the trained machine learning model, since different types of annotations can provide different meta information about the classes to be segmented, e.g., concerning the location, extent or relevance of the respective object or points within the training image. For example, positive partial pixel level annotations such as scribbles or points usually indicate locations in the center of the object or locations that are specifically of interest. Subset level annotations such as bounding boxes provide additional information about the spatial extent of an object. Positive image level annotations often provide information about the most prominent or most relevant objects within an image. Such meta information can automatically be extracted and learned by a machine learning model, thereby improving the accuracy of the predictions. Throughout this disclosure, the accuracy of a trained machine learning model refers to the accuracy of the predictions of the trained machine learning model.

As the loss function at at least one pixel depends on the types of annotations at the pixel and within the batch, the loss function can flexibly incorporate information provided by all kinds of annotation types, e.g., specific information provided by complete pixel level annotations or positive partial pixel level annotations, less specific information provided by subset level annotations, positive image level annotations, negative partial pixel level annotations or negative image level annotations, or indirect information for pixels lying outside all annotations. By specifically tailoring the loss function for each pixel within each training image depending on the annotations at that pixel, the information provided by the annotations can be leveraged most efficiently and accurately during training of the machine learning model. In this way, the accuracy of the predictions of the machine learning model is improved.

The dependency of the loss function on the available annotation types at a pixel and within the batch has the advantage that the information contained in each annotation type can be optimally utilized for training the machine learning model. This is because each annotation type assigns pixel classes in different ways, and the other examples within a batch serve to differentiate them from other classes (contrastive learning). Thus, time-saving weak annotation types can also be optimally integrated into the training. A pixelwise formulation of the loss function allows several annotation types to be present within a single image or at a single pixel. This makes processing of images containing different annotation types possible. This improves the flexibility of the training and allows the user to perfectly tailor the annotation types to the task to be solved and to the content of the image to obtain highly accurate predictions within a short period of time. This also saves computing resources and energy.

The annotation type dependent loss function can be used to learn a pixelwise mapping to a feature space. The mapping maps a pixel in an input image to an embedding vector in the feature space. The feature space can then be used to associate pixels to classes based on their embedding vectors in the feature space. Class associations can, for example, be established in the feature space based on the distance of an embedding vector of a pixel and one or more, preferably two or more, or even multiple, characteristic elements of each class in the feature space.

The term image or training image throughout this disclosure can refer to 2D images, stacks of images, 3D volumes, or videos of 2D images, stacks of images or 3D volumes. In case of a 3D volume the term pixel is to be understood as voxel. The 3D volume consists of slices. A batch of training images can comprise a single training image, a subset of training images, e.g., 32 or 64, or all training images.

An annotation comprises one or more pixels of a training image and an indicated class label. A training image can contain no, one or more than one annotation. Different annotations within a training image can be of the same annotation type or of different annotation types. Each image can contain annotations of one or more than one type. An image without annotations is referred to as an unannotated image. A pixel in a training image can belong to no, one or more than one annotation. An annotation can be obtained by letting a user mark training images, subsets of training images or pixels within training images and indicate a class label. An annotation can also be obtained automatically, e.g., by applying a labeling algorithm to the training images, for example an image classification or an object detection algorithm. Throughout this disclosure, a portion of the pixels of a set (e.g., an image or a subset thereof) can comprise one or more pixels of the set, but not all of them.

Complete pixel level annotations comprise all pixels of a training image that are assigned to the indicated class, in case the training image is fully labeled. Thus, within a fully labeled training image, all pixels labeled with a specific class label form a complete pixel level annotation for the specific class label. An annotation for a specific class is a complete pixel level annotation if the training image is fully labeled and all pixels labeled as the specific class in the training image are assigned to the annotation. Thus, for a complete pixel level annotation, the training image does not contain any other pixels assigned to the specific class apart from the pixels of the complete pixel level annotation. Complete pixel level annotations are sometimes referred to as masks in the literature.

Positive partial pixel level annotations comprise a portion of the pixels of the training image that are assigned to the indicated class. The indicated class label is assigned to all pixels of the positive partial pixel level annotation. An annotation for a specific class is a positive partial pixel level annotation if the training image is not fully labeled, or if the training image is fully labeled but the annotation does not contain all pixels assigned to the specific class. Thus, for a positive partial pixel level annotation, the training image can contain further pixels belonging to the specific class that are not assigned to the positive partial pixel level annotation. Positive partial pixel level annotations comprise, for example, scribbles, points, click points, points of interest, regions, polygons, etc.

Subset level annotations comprise a subset of the training image, such that a portion of the pixels within the subset is assigned to the indicated class. A subset can, for example, comprise a 2D region within a training image, or a 3D region within a stack of images or within a 3D volume. Different kinds of subset level annotations can be defined, e.g., by further specifying the portion of pixels assigned to the indicated class. For example, a subset level annotation can comprise a subset of the training image, such that at least one pixel within the subset is assigned to the indicated class. For example, a subset level annotation can comprise a subset of the training image, such that within each row and within each column of the subset (and within each slice of the subset in case of a 3D volume training image) at least one pixel (voxel) is assigned to the indicated class. For example, a subset level annotation can comprise a subset of the training image, such that none of the pixels outside the subset level annotation is assigned to the indicated class, i.e., the subset level annotation encompasses all pixels of the training image that belong to the indicated class. Similarly, it can be assumed that all subset level annotations in a training image collectively encompass all pixels in the training image belonging to the indicated class. Subset level annotations comprise, for example, bounding boxes of any shape and size, e.g., geometric objects such as rectangles, circles, ellipses of any size etc. Subset level annotations can, for example, be obtained automatically by applying an object detection algorithm to the training images that assigns class labels and bounding boxes to objects within the training images.

Positive image level annotations comprise a training image such that a portion of the pixels of the training image is assigned to the indicated class. One training image can contain multiple positive image level annotations in case each of the positive image level annotations indicates a different class label. Positive image level annotations can, for example, be obtained automatically by applying an image classification algorithm to the training images that assigns class labels to training images.

Negative partial pixel level annotations comprise a portion of the pixels of the training image that are not assigned to the indicated class. Thus, none of the pixels of the negative partial pixel level annotation is assigned to the indicated class.

Negative image level annotations comprise the training image, wherein none of the pixels of the training image is assigned to the indicated class.

Further types of annotations are conceivable.

In a preferred embodiment of the invention, the formulation of the loss function at more than half of the pixels of the training images, more preferably at at least 70% of the pixels of the training images, most preferably at at least 90% of the pixels of the training images depends on the types of annotations at the pixels and on the types of annotations within the batch.

In a preferred embodiment of the invention, the training images collectively contain at least two different types of annotations.

According to an example of the first embodiment of the invention, the number of annotations of each type of the at least three types of annotations make up at least 10%, preferably at least 15%, more preferably at least 20%, most preferably at least 30% of all annotations of all training images. Alternatively, a distribution over the frequency of annotation types used during training can be defined. Thus, annotations of all types occur sufficiently often in the training data such that the machine learning model can derive meta information from each annotation type. In this way, the accuracy of the trained machine learning model is improved.

In a preferred example, at least one training image contains at least two annotations of different types. In particular, multiple training images contain at least two annotations of different types. In an example, the at least two annotations of different types have the same class label. In an example, the at least two annotations of different types have a different class label. In this way, the flexibility of the expert annotator during the annotation is improved, the time required for annotation is reduced, and the accuracy of the predictions of the machine learning model is improved due to more flexible and application dependent annotation possibilities.

In a preferred example, at least one pixel of at least one training image belongs to at least two annotations of different types. In particular, multiple pixels of multiple training images each belong to at least two annotations of different types. In an example, the at least two annotations of different types have the same class label. In an example, the at least two annotations of different types have a different class label. In this way, the flexibility of the expert annotator during the annotation is improved, the time required for annotation is reduced, and the accuracy of the predictions of the machine learning model is improved due to more flexible and application dependent annotation possibilities.

Preferably the machine learning model is configured as a neural network, in particular as a neural network configured for deep learning.

According to an example of the first embodiment of the invention, the at least three types of annotations comprise complete pixel level annotations or positive partial pixel level annotations. Complete or positive partial pixel level annotations for a specific class label assign each pixel in the annotation to the specific class. Thus, the machine learning model is provided with a large variety of pixels that all belong to the specific class. In this way, the accuracy of the machine learning model is improved.

According to an aspect of the first embodiment of the invention, the at least three types of annotations comprise positive image level annotations. Positive image level annotations can be obtained quickly and easily requiring only little user effort. In addition, they provide a high-level view of the image usually indicating important or prominent objects within the image and, thus, valuable information for training. Thus, they are a good complement for complete pixel level annotations in terms of information content and user effort. Hence, they increase the accuracy of the machine learning model without requiring much user effort.

In a preferred example, the at least three types of annotations comprise complete pixel level annotations and positive image level annotations.

In another preferred example, the at least three types of annotations comprise positive partial pixel level annotations and positive image level annotations.

In an even more preferred example, the at least three types of annotations comprise complete pixel level annotations or positive partial pixel level annotations and subset level annotations and positive image level annotations.

In an example of the first embodiment of the invention, the types of annotations are from a group consisting of complete pixel level annotations, positive partial pixel level annotations, subset level annotations, positive image level annotations, negative partial pixel level annotations and negative image level annotations.

In an example of the first embodiment of the invention, the types of annotations are from a group comprising complete pixel level annotations, positive partial pixel level annotations, subset level annotations and positive image level annotations.

In an example of the first embodiment of the invention, the types of annotations are from a group consisting of complete pixel level annotations, positive partial pixel level annotations, subset level annotations and positive image level annotations.

According to an example of the first embodiment of the invention, the iteratively presented batches of training images are configured such that for each type of annotation a training image exists, such that all other types of the at least three different types of annotations are contained in at least one training image of the preceding training images. In this way, it is ensured, that all types of annotations are used within each training. This prevents that training is started with a subset of the annotation types only on a dataset and re-training is carried out with the remaining or additional annotation types on the same or a different dataset later. By using all annotation types within each training cycle, the machine learning model is provided with information of different specificity within each training cycle, such that the machine learning model can use the most valuable kind of information. It can even discover meta information such as locality, extent or relevance information as well. In this way, the accuracy of the machine learning model is improved.

According to an example of the first embodiment of the invention, the loss function comprises a contrastive loss function for semantic image segmentation, in particular a decoupled contrastive loss function. The contrastive loss function is used to learn a pixelwise mapping to a feature space for semantic image segmentation. The feature space is used to associate a pixel to a class. The pixelwise mapping can map a single pixel to the feature space or a vector of pixels, e.g., a neighborhood of pixels in an image. A contrastive loss function learns representations of input vectors in a feature space by grouping similar input vectors or input vectors sharing one or more characteristics such as class association (positive associations) and contrasting between dissimilar input vectors or input vectors not sharing one or more characteristics such as class association (negative associations). Similar input vectors are mapped to feature vectors (embedding vectors) that are close to each other in the feature space, whereas dissimilar input vectors are mapped to feature vectors (embedding vectors) that are far apart in the feature space. In this way, the input vectors are clustered in the feature space according to their similarity or one or more common characteristics. Thus, assigning the input vectors to classes is simplified in the feature space. In this way, the accuracy of the machine learning model is improved. An input vector can contain a single pixel or two or more pixels, e.g., a neighborhood of pixels in an image.

Instead of learning a mapping to a feature space based on the similarity and dissimilarity of input vectors, according to a preferred example of the invention, the mapping to the feature space is learned with respect to one or more characteristics of the input vectors, e.g., their class association. Thus, the contrastive loss function groups input vectors that share the same characteristics, e.g., a class association, and contrasts between input vectors having different characteristics, e.g., a class association. In this way, the input vectors are clustered in the feature space according to the one or more characteristics, e.g., their class association. Thus, the feature space groups embedding vectors of pixels of annotations with the same class label and contrasts embedding vectors of pixels of annotations with different class labels. In this way, the association of a pixel to a class can be established via the learned mapping and the learned feature space.

A decoupled contrastive loss function decouples positive associations from negative associations by using associations either as positive or as negative associations but not as positive and negative associations. In this way, the feature space is learned more efficiently and is better suited for separating between feature vectors of different classes.

The terms “feature vector” and “embedding vector” are used interchangeably throughout this disclosure.

According to an aspect of the first embodiment of the invention, the contrastive loss function is configured such that the association of the pixels of an annotation to the class indicated by the annotation is encouraged, while the associations of pixels outside the annotation to a class are attenuated if the class is different from the class indicated by the annotation or if the class is equal to the class indicated by the annotation but incompatible with the annotations at the pixels outside the annotation. In this way, the concepts of contrastive learning and multiple-instance learning are combined to allow for the integration of different types of user annotations within the same loss function. Multiple-instance learning provides concepts for handling weak annotation types such as subset level annotations or positive image level annotations, while contrastive learning allows to optimize semantic clusters in a feature space. In case of pixels lying outside all annotations in a training image, information can be derived indirectly from the annotations of other pixels by use of the contrastive loss function.

According to an aspect of the first embodiment of the invention, the way the association of the pixels of an annotation to the class indicated by the annotation is encouraged depends on the type of the annotation. In this way, the loss function at each pixel can be specifically designed to the specific combination of annotations containing that pixel and, thus, derive information from these annotations in a very efficient and accurate way. For example, information derived from a complete pixel level annotation or positive partial pixel level annotation should have more influence on the label than information derived from a less specific subset level or positive image level annotation or from a negative partial pixel level annotation or a negative image level annotation. To this end, the association of the pixels of an annotation to the class indicated by the annotation can be weighted by a weighting factor depending on the type of the annotation. Each specific combination of annotations at a pixel, thus, leads to a different, specialized loss function at that pixel. In this way, a general and flexible concept for integrating various types of annotations in a loss function is given, while at the same time the accuracy of the trained machine learning model is improved.

According to an example of the first embodiment of the invention, the contrastive loss function is of the form

$${L}_{DSP} = {\sum }_{t ∈ τ} {λ}_{t} {\sum }_{c ∈ C} ( - {s}_{pos} ( {Ω}_{c}^{t} ) + {s}_{neg} ( {Ω}_{c}^{t} ) )$$

$$where$$

$${s}_{neg} ( {Ω}_{c}^{t} ) = log ( {\sum }_{j = 1}^{B \cdot H \cdot W} {\sum }_{k = 1 , k \neq c ∨ c ∉ {A}_{j}}^{C} {s}_{k} ( {f}_{j} , {P}_{k} ) ) ,$$

wherein t∈T indicates the type t of an annotation from a set T of annotation types, λₜ indicates a weighting factor for annotations of type t, c∈C indicates the class c of a set of classes C, H indicates the height and W the width of the training images, B indicates the batch size,

$${s}_{pos} ( {Ω}_{c}^{t} )$$

indicates the positive associations of annotation

$${Ω}_{c}^{t}$$

of type t to class c, and

$${s}_{neg} ( {Ω}_{c}^{t} )$$

indicates the negative associations for annotation

$${Ω}_{c}^{t} , {s}_{k} ( {f}_{j} , {P}_{k} )$$

indicates the association of a pixel j represented by the embedding vector fⱼ to class k, Pₖ indicates a set of characteristic elements for class k, and Aⱼ indicates the set of classes compatible with pixel j with respect to annotations at pixel j. This contrastive loss function is adapted to the problem of semantic image segmentation. It enforces positive associations of pixels to classes indicated by the annotations. At the same time associations of other pixels to other classes and associations of other pixels to the same class in case this class is incompatible with the annotations at that pixel are attenuated. This formulation of the loss function can be flexibly adapted to any type of user annotation. It combines contrastive learning with instance learning for semantic image segmentation. Thus, the accuracy of the trained machine learning model is improved.

In an example, the association of the pixels of a subset level annotation to the class indicated by the subset level annotation comprises a function of one or more line-wise and/or row-wise maxima of the associations of the pixels of the subset level annotation to the class indicated by the subset level annotation. In the same or another example, the association of the pixels of a positive image level annotation to the class indicated by the positive image level annotation comprises the average of all associations of the pixels of the positive image level annotation to the class indicated by the positive image level annotation.

According to an example of the first embodiment of the invention, the machine learning model maps each pixel of an input image to an embedding vector of the pixel in a feature space, and the association of a pixel to a class is measured in this feature space. The feature space can be specifically designed or computed such that features important for the association of the pixel with a class are obtained from the pixel and, potentially, its neighborhood in the image. The feature space can, for example, comprise the output of an intermediate layer of a trained neural network, e.g., a neural network trained for image segmentation or semantic image segmentation. Pixels are mapped into this feature space by presenting an input vector, e.g., comprising a neighborhood of the pixel or the image containing the pixel to the network and selecting the corresponding output vector in the intermediate layer. Alternatively, a pixel can be mapped into a feature space by applying filters to the image or the neighborhood of the pixel, e.g., Gabor filters, edge filters, frequency filters, high pass filters, low pass filters, or by applying edge detectors to the image, or by computing SIFT features, HOG features, LBP features, histograms, etc. By mapping the pixels into the feature space and computing class associations in the feature space, the accuracy of the trained machine learning model is improved. If the feature space is of lower dimensionality than the input vector, computation time can be reduced due to dimensionality reduction.

According to an example of the first embodiment of the invention, the association of a pixel to a class is measured by the similarity of an embedding vector of the pixel in a feature space and one or more, preferably two or more, more preferably multiple, characteristic elements of the class in the feature space. A characteristic element refers to an embedding vector in the feature space. By representing a class in the feature space by two or more, or by multiple characteristic elements, the intra-class variability and multi-modal distributions can be taken into account, e.g., diverse appearances, variants or characteristics of the class. In this way, highly variable classes with different characteristics or appearances can be represented in the feature space. Thus, the accuracy of the machine learning model is improved. The number of characteristic elements for each class can be the same for all classes, or it can be different for some or each of the classes. The number can, for example, depend on the variability of the class, e.g., on the number of modes of a multi-modal distribution representing the class in feature space. In case of two or more characteristic elements in a class, the association of a pixel to the class can be measured using a function of the similarities of an embedding vector of the pixel in the feature space and the two or more characteristic elements of the class in the feature space, in particular an average, a median, a sum or a maximum of the similarities of the embedding vector with each of the two or more characteristic elements.

The similarity of two embedding vectors in the feature space (e.g., a pixel embedding vector and a characteristic element) can, for example, be measured using the angle between the embedding vectors, e.g., a cosine distance. The similarity between an embedding vector and a set of embedding vectors representing a class in the feature space can be measured by the average similarity of the embedding vector and each embedding vector of the set of embedding vectors representing the class.

According to an aspect of the first embodiment of the invention, the characteristic elements of each class belong to the parameters of the machine learning model, which are optimized by minimizing the loss function during the iterations of the training. Thus, the characteristic elements are directly optimized together with the other parameters of the machine learning model during training. Hence, no error-prone rules, additional knowledge or additional algorithms are required for estimating characteristic elements for a class. In this way, the accuracy of the trained machine learning model is improved, and the optimization of the parameters is simplified.

Alternatively, a class in the feature space can be represented by a probability distribution in the feature space, e.g., by a parametric distribution or by a non-parametric distribution derived from class samples. Then the association of an embedding vector and a class can be computed using statistics, e.g., confidence intervals, p-values, etc.

According to an example of the first embodiment of the invention, the computer implemented method for training a machine learning model for semantic image segmentation further comprises using augmented training images with pseudo-annotations during training of the machine learning model, wherein the augmented training images are generated by modifying training images, and wherein the pseudo-annotations are generated by presenting the augmented training images to the machine learning model and obtaining class labels, and wherein the loss function is configured to filter the pseudo-annotations by preventing the association of a pixel in an augmented training image to the class indicated by the pseudo-annotation at that pixel if the pseudo-annotation is not compatible with an annotation at the corresponding pixel in the training image annotation. By using augmented training images with pseudo-annotations, the amount of training data can be automatically increased. Thus, the amount of required training data is reduced. In addition, invariance of the trained machine learning model towards standard image processing operations such as rotation, translation, flipping, changes in contrast, brightness or hue is achieved. Thus, the accuracy of the trained machine learning model is improved. However, the generated pseudo-annotations can contain incorrect label assignments, which are inevitably used during training along the correct label assignments. Thus, by configuring the loss function to filter pseudo-annotations incompatible with the annotations incorrect label assignments are prevented and the accuracy of the trained machine learning model is improved even further.

In an example, the pseudo-annotation is not compatible with an annotation at the corresponding pixel in the corresponding training image, if the pseudo-annotation contradicts the class label indicated by a complete pixel level annotation or positive partial pixel level annotation at the corresponding pixel in the corresponding training image, or if the corresponding pixel lies outside all subset level annotations indicating the class label of the pseudo-annotation in the corresponding training image, or if one or more image-level annotations exist for the corresponding training image and the class label of the pseudo-annotation is not indicated by any of the one or more positive image level annotations.

According to an aspect of the first embodiment of the invention, the augmented training images are obtained by applying one or more operations from the group comprising flipping, rotation, translation, contrast variation, brightness variation, saturation variation and hue variation to the corresponding training images, and for each augmented training image one or more strongly augmented training images are obtained by applying one or more arbitrary image processing operations to the corresponding training image, wherein the loss function is configured to filter the pseudo-annotations of the augmented training images and to measure the deviation of the machine learning model class associations on the strongly augmented training images from the filtered pseudo-annotations of the corresponding augmented training images. For example, the loss function can comprise a cross entropy loss function measuring the deviation of the class associations on the strongly augmented training images from the filtered pseudo-annotations of the corresponding augmented training images. By using strongly augmented training images and comparing their class associations to the filtered pseudo-annotations of the corresponding augmented training images, the machine learning model learns to further generalize its knowledge to training images with more complicated modifications such as pixel modifications or cut-outs, thereby improving the accuracy of the trained machine learning model. The filtering of pseudo-annotations using annotations prevents incorrect label associations.

According to an example of the first embodiment of the invention, the training images comprise unannotated training images. Unannotated training images are easily available in most application domains. Even without annotations they still provide valuable information that can be leveraged during training of the machine learning model. For example, feature spaces can be learned, e.g., to characterize or reconstruct patterns in the unannotated training images, or similar images or image subsets can be clustered using unannotated training images. Thus, the accuracy of the trained machine learning model is improved.

In an example of the first embodiment of the invention, the loss function comprises a cross entropy loss function for the pixels of the complete pixel level annotations or positive partial pixel level annotations. Complete pixel level annotations or partial pixel level annotations provide highly specific information for labeling, since each pixel is assigned to exactly one class. Thus, such annotations are important for semantic image segmentation and help to improve the accuracy of the trained machine learning model.

According to an aspect of the first embodiment of the invention, any combination of two or more loss functions from the group comprising a contrastive loss function as described above, a pseudo-annotation filtering loss function as described above and a cross entropy loss function for complete pixel level annotations or positive partial pixel level annotations can be used for semantic image segmentation with annotations of at least three different types.

Experiments, in fact, show that—contrary to the common belief that pixel level annotations yield the most accurate machine learning models—the use of annotations of varying specificity (i.e., complete pixel level annotations or positive partial pixel level annotations, subset level annotations, positive image level annotations, negative partial pixel level annotations, negative image level annotations) together in a loss function depending on the annotation type increases the accuracy of the trained machine learning model.

According to an example of the first embodiment of the invention, the computer implemented method for training a machine learning model for semantic image segmentation further comprises retraining the machine learning model on a subset of the training images with annotations of increased specificity. The specificity of an annotation can, for example, be measured by the portion of pixels within the annotation that is at least assigned to a class label indicated by the annotation and by the number of class labels the portion of pixels is assigned to (which can be larger than 1 in case of negative partial pixel annotations and negative image level annotations). For example, the specificity of a positive image level annotation in a training image is increased by adding one or more subset level annotations or one or more positive partial pixel level annotations with the same class label to the training image, and the specificity of a subset level annotation in a training image is increased by adding one or more positive partial pixel level annotations with the same class label within the subset in the training image. In this way, the machine learning model can be iteratively re-trained using annotations of increasing specificity. Thus, the machine learning model can first learn from mainly high-level knowledge provided by a larger amount of positive image level annotations and subset level annotations, whereas during later training cycles mainly low-level knowledge is provided by a larger amount of complete pixel level annotations or positive partial pixel level annotations. In this way, the accuracy of the machine learning model is improved. At the same time, the generation of annotations is simplified, since large amounts of highly specific annotations are only required in later training cycles. The machine learning model can, thus, be successively adapted to the specificity of available annotations. Expert annotators can, thus, first use less specific annotations for most training images and specify their annotations further in a later stage of training.

A computer implemented method for semantic image segmentation according to a second embodiment of the invention comprises obtaining an image and applying the machine learning model trained using a method according to the first embodiment of the invention to the obtained image to obtain a semantic image segmentation.

A data processing apparatus according to a third embodiment of the invention is configured for carrying out a method according to the first embodiment of the invention.

A system for semantic image segmentation according to a fourth embodiment of the invention comprises an imaging device configured to provide an image of a scene, e.g., of an object, one or more processing devices, and one or more machine-readable hardware storage devices comprising a machine learning model trained using a method according to the first embodiment of the invention and comprising instructions that are executable by one or more processing devices to apply the trained machine learning model to the image of the scene, e.g., of an object.

A computer program according to a fifth embodiment of the invention comprises instructions which, when the program is executed by a computer, cause the computer to carry out a method according to the first or second embodiment of the invention.

A computer-readable medium according to a sixth embodiment of the invention has a computer program executable by a computing device stored thereon, the computer program comprising code for executing a method according to the first or second embodiment of the invention.

The invention described by examples and embodiments is not limited to the embodiments and examples but can be implemented by those skilled in the art by various combinations or modifications thereof.

### DESCRIPTION OF DRAWINGS

FIG. 1 illustrates a computer implemented method for training a machine learning model for semantic image segmentation;

FIG. 2 illustrates a flowchart of the computer implemented method for training a machine learning model for semantic image segmentation according to a first embodiment of the invention;

FIG. 3 illustrates the association of a pixel in an input image to a class;

FIG. 4 illustrates the formation of the denominator of a contrastive loss function, the denominator comprising the negative associations for a pixel of a first class for different annotation types;

FIG. 5 illustrates a computer implemented method for training a machine learning model for semantic image segmentation according to an example of the first embodiment of the invention;

FIG. 6 shows a flowchart of a computer implemented method for semantic image segmentation according to a second embodiment of the invention;

FIG. 7 illustrates a data processing apparatus according to a third embodiment of the invention;

FIG. 8 illustrates a system for semantic image segmentation;

FIGS. 9A-9D illustrate the accuracy of the trained machine learning models for decreasing amounts of annotations in the expert application domain of biology;

FIG. 10 shows ablation studies illustrating the sensitivity of the trained machine learning model according to the first embodiment of the invention with respect to selected parameters;

FIG. 11 shows qualitative results on an image comprising five different class labels;

FIG. 12 illustrates a schematic section through an apparatus which can perform a method according to the invention and a local chemical sample repair process;

FIG. 13 illustrates a user interface for displaying and annotating images;

FIGS. 14A-14G show different annotation types for an image of a photomask comprising a contamination defect;

FIG. 15 illustrates an annotation process for providing at least three different types of annotations in a photomask image;

FIGS. 16A-16G show different annotation types for a medical image comprising a tumor;

FIG. 17 illustrates an annotation process for providing at least three different types of annotations in an MRI image;

### DETAILED DESCRIPTION

In the following, advantageous exemplary embodiments of the invention are described and schematically shown in the figures. Throughout the figures and the description, same reference numbers are used to describe same features or components. Dashed lines indicate optional features.

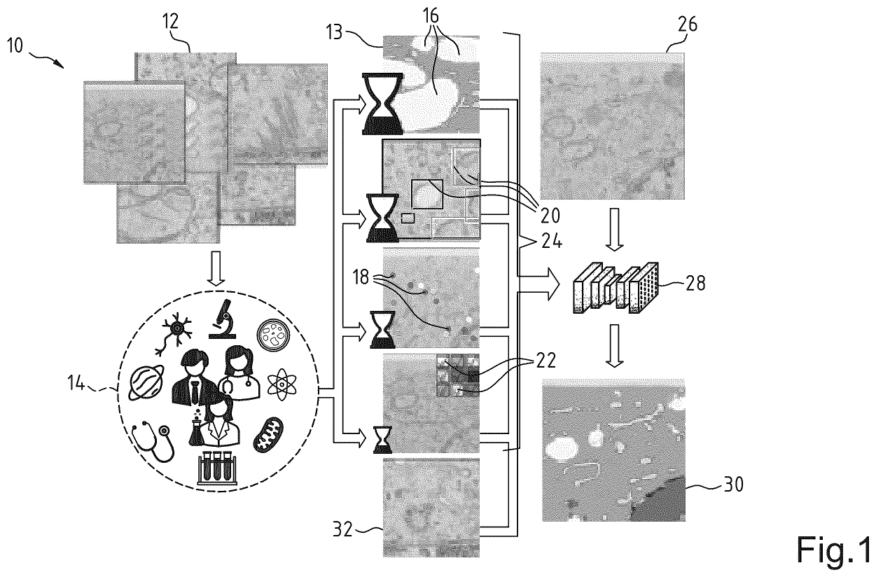

FIG. 1 illustrates a computer implemented method 10 for training a machine learning model 28 for semantic image segmentation, i.e., for segmenting an image into classes. For a given set of training images 12, e.g., medical images or biological images, expert annotators 14 from the respective application domain add annotations 24 to the training images 12. Alternatively, annotations 24 can be generated automatically. The annotations 24 given by the expert annotators 14 in FIG. 1 comprise four different types of annotations 24: complete pixel level annotations 16, positive partial pixel level annotations 18 in the form of points, subset level annotations 20 in the form of bounding boxes and positive image level annotations 22. In addition, unannotated training images 32 can also be used for training.

The images, in particular the training images 12, throughout this disclosure can be 2D images comprising pixels, 2D image stacks or videos comprising slices of 2D images or 3D volumes comprising voxels. The images may comprise channels, e.g., at least one or two or three or four or five channels, e.g., RGB or multiple fluorescence channels. The images may be generated using one of the following techniques: (medical) Computed Tomography (CT), Optical Coherence Tomography (OCT), Optical Coherence Tomography Angiography (OCT-A), especially retinal OCT-A, Magnetic Resonance Imaging (MRI), ultra-sound imaging (sonography), any of the previous variants especially taken in an intra-operative setting, light microscopy, e.g., acquiring adjacent z-slices, e.g., scanning through a three-dimensional object with a confocal microscope and a focus on slightly different z-levels, e.g., with lightsheet imaging, lattice lightsheet imaging, hyperspectral microscopy imaging, wide-field imaging with acquired focus stacks, or imaging-techniques which are molecularly sensitive (e.g., fluorescence imaging, auto-fluorescence imaging, fluorescence lifetime imaging microscopy (FLIM)), dynamic cell imaging (DCI), structured illumination microscopy, holography, holotomography, optical coherence microscopy, quantitative phase imaging (QPI), time series imaging, e.g., videos consisting of RGB images or gray value images which are acquired over time, e.g., in operation rooms, or fluorescence recordings of living samples over time, XRay-microscopy, e.g., taking multiple X-ray measurements of a sample under different viewpoints and aggregating them into a volumetric representation via a tomographic reconstruction, electron microscopy, e.g., imaging z-stacks of adjacent z-slices with a scanning electron beam of a scanning electron microscope (SEM), or slices milled with a focused ion beam (FIB) and imaged with a SEM, Helium-Ion-beam of a Helium ion microscope (HIM) or the like.

The images may be obtained using an imaging apparatus configured for any one of the abovementioned imaging variants. The imaging apparatus may also be used for imaging of samples of different sorts, e.g., wafers, masks, etc. in semiconductor applications, molecules, cells, cell compounds, spheroids, organoids, etc., in research microscopy applications, parts or organs or parts of organs of humans, e.g., eye, retina, brain, neck, ear, teeth, etc., in medical applications, stones, minerals, additively manufactured objects, subtractive manufactured objects, etc., in industrial quality assurance applications, and the like. Accordingly, the images may be taken by an apparatus for any one of the imaging variants as mentioned above.

Each training image 12 may comprise annotations 24. In training image stacks or training 3D volumes one or more slices can comprise annotations 24, while other slices do not comprise annotations 24, e.g., only individual slices can be annotated. Therefore, the training images 12 can comprise images with annotations 24 alongside unannotated training images 32.

In an embodiment, the annotations 24 may be obtained from at least one human, preferably from at least one human expert in the field of the application. In another embodiment, the annotations 24 may be given by or derived from a second recorded modality, such as a second imaging apparatus and/or imaging variant. As an example, an annotation for cells in wide-field microscopy images may be obtained from additionally recorded fluorescence microscopy images.

Complete pixel level annotations 16 and positive partial pixel level annotations 18 assign pixels of a training image 12 to the indicated class. Complete pixel level annotations 16 (also called masks) are obtained from fully labeled training images 13. A complete pixel level annotation 16 for an indicated class comprises all pixels of the fully labeled training image 13 that are assigned to the indicated class. Positive partial pixel level annotations 18 for an indicated class comprise a portion of the pixels of the training image 12 that are assigned to the indicated class. Various examples for positive partial pixel level annotations 18 exist, e.g., scribbles, points, regions, polygons or interest points. Scribbles can be obtained by recording the pixels touched by mouse strokes over the training image. Points or interest points can be obtained by clicking on the training image. Regions comprise larger portions of the pixels of the training image and can be obtained, e.g., by drawing shapes such as polygons on the training image 12. All the pixels within the positive partial pixel level annotation 18 are assigned to the indicated class. In this way, an exact mapping between pixels and classes are established. Complete pixel level annotations 16 and positive partial pixel level annotations 18 are specific and well suited for training the machine learning model 28. However, they require a lot of time and effort from the expert annotators 14 during annotation.

Subset level annotations 20 and positive image level annotations 22 are less specific, since they only indicate the occurrence of a class within the subset or training image 12 without exactly localizing the specific pixels within the subset or training image 12.

Subset level annotations 20 comprise a subset of the training image, within which a portion of the pixels is assigned to the indicated class. Subset level annotations 20 comprise, for example, bounding boxes of any shape. Subset level annotations 20 can, for example, be obtained by object detection applications. Object detection applications assign a set of bounding boxes with indicated classes to an image, each bounding box containing an object of the indicated class in the image.

Positive image level annotations 22 comprise the training image 12, within which a portion of the pixels is assigned to the indicated class. Positive image level annotations 22 can, for example, be obtained from classification applications. Classification applications assign a set of class labels to an image, the class labels indicating the types of objects occurring in the image. Subset level annotations 20 and positive image level annotations 22 are less specific than complete pixel level annotations 16 or positive partial pixel level annotations 18, but they are much faster to obtain, to verify and to correct and, thus, save the expert annotators 14 a lot of time and effort. The training images 12 can additionally comprise unannotated training images 32.

Negative partial pixel level annotations comprise a portion of the pixels of the training image 12 that are not assigned to the indicated class. Thus, none of the pixels of the negative partial pixel level annotation is assigned to the indicated class. Negative partial pixel level annotations are less specific than complete pixel level annotations 16 or positive partial pixel level annotations 18, since the pixels can be assigned to any of the other classes.

Negative image level annotations 23 comprise the training image 12, wherein none of the pixels of the training image 12 is assigned to the indicated class. Negative image level annotations 23 are more specific than positive image level annotations 22, since they forbid a class label at each single pixel in the training image 12, while positive image level annotations 22 only assign at least one pixel in the training image 12 to a class label.

Subset level annotations 20, positive image level annotations 22, negative partial pixel level annotations and negative image level annotations 23 are also called weak annotations. Each training image can comprise none, one, several or all of the annotation types. Each pixel in a training image 12 can be part of none, one, several or all of the annotations 24 provided for that training image 12.

Less specific annotations 24 can be derived from more specific annotations 24. For example, any type of annotation 24 can be derived from a training image 12 with a complete pixel level annotation 16, e.g., by extracting positive partial pixel level annotations 18 such as points or regions from the complete pixel level annotations 16, by defining subset level annotations 20 such as bounding boxes encompassing the labeled objects in the complete pixel level annotations 16, or by deriving positive image level annotations 22 by only extracting the classes from the complete pixel level annotation 16. Negative partial pixel level annotations and negative image level annotations 23 can be obtained using the class labels not assigned to the respective pixels. Similarly, subset level annotations 20 and positive image level annotations 22 can be obtained from positive partial pixel level annotations 18. Similarly, positive image level annotations 22 can be obtained from subset level annotations 20. Finally, unannotated training images 32 can be obtained from training images 12 with any kind of annotation 24.

The annotations 24 used to train the machine learning model 28 for semantic image segmentation comprise at least three different types of annotations 24. In a preferred embodiment of the invention, the annotations 24 comprise at least four different types of annotations 24, thus allowing the expert annotators 14 to use more flexible annotation types. In this way, the annotations 24 can be specifically tailored to the application domain and/or to the contents of each training image 12, thereby using the available expert annotator resources most efficiently. Thus, the accuracy of the predictions of the trained machine learning model can be improved and the time required for training can be reduced.

In a preferred example, at least one training image 12 contains at least two annotations 24 of different types. In particular, multiple training images 12 contain at least two annotations 24 of different types. In a preferred example, at least one pixel of at least one training image 12 belongs to at least two annotations 24 of different types. In particular, multiple pixels of multiple training images 12 each belong to at least two annotations 24 of different types.

According to an example of the first embodiment of the invention, the number of annotations 24 of each type of the at least three types of annotations make up at least 10% of all annotations 24, preferably 15% of all annotations 24, more preferably 20% of all annotations 24 and most preferably 30% of all annotations 24. Alternatively, a specific distribution over the portion of training images 12 per annotation type can be indicated, e.g., by a user. Alternatively, a specific distribution over the portion of training images 12 per annotation type and class label can be indicated, e.g., by a user.

The training images 12 together with the provided annotations 24 are used to train a machine learning model 28 for semantic image segmentation. The trained machine learning model 28 can then be used to make predictions of class labels for unknown input images 26 yielding a semantic image segmentation 30 in the form of a labeled output image.

The number of training images 12 required for training the machine learning model 28 depends on the application domain, the complexity of the segmentation task, and the quality of the available annotations. In general, at least ten training images 12 may be sufficient to obtain a functioning prototype model, whereas robust models typically require at least one hundred training images 12, and in many cases at least one thousand training images 12 or more are advantageous. The minimum number of annotations further depends on the annotation type: for complete pixel-level annotations 16, a relatively small number of images may suffice, for example, at least 10 to 50 images, as each annotation provides dense pixel-wise information. For partial pixel-level annotations 18, 19, a higher number of annotated images is usually needed, e.g., at least 100 images, since only portions of the pixels are labeled. For subset-level annotations 20 and image-level annotations 22, even larger datasets may be required, e.g., at least several hundred to several thousand images, because each annotation conveys only coarse supervision. For example, a medical segmentation task with high-quality full annotations may achieve satisfactory results with about 100 annotated images, whereas a natural image segmentation task with only positive or negative image-level annotations may require thousands of training images to reach comparable accuracy.

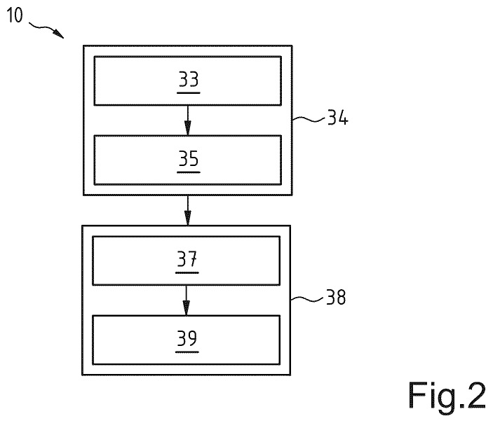

FIG. 2 illustrates a flowchart of the computer implemented method 10 for training a machine learning model 28 for semantic image segmentation according to a first embodiment of the invention comprising a training image step 34 and a training step 38. In the training image step 34, training images 12 collectively containing at least three different types of annotations 24 are obtained, wherein each annotation 24 comprises one or more pixels of a training image 12 and an indicated class label.

The training image step 34 comprises a training image providing step 33, an annotation step 35, and a storing step 37. In the training image providing step 33, training images are obtained, for example, by capturing images with an image acquisition device such as a digital camera, a microscope, or a scanning system, depending on the application. The images are then provided to an expert by use of a user interface, which may include a display for presenting the training images. In the annotation step 35, the expert provides annotations by interacting with the user interface, for example, by using a mouse, a keyboard, or a touchscreen. The user interface may be configured to receive three or more different types of annotations, such as complete pixel-level annotations, partial pixel-level annotations, subset-level annotations, or image-level annotations. Annotations may be given by marking pixels on a screen, by drawing bounding boxes, by using text labels, etc. The user interface may prompt the expert to provide three or more types of annotations, for example, by displaying corresponding annotation options or by guiding the expert through an annotation workflow, so that the expert is aware of the required annotation types. Furthermore, the user interface may be pre-programmed with all class labels relevant to the training task, so that the expert can select the correct class for each annotation. In the storing step 37, the training images together with their associated annotations are stored in a storage device, such as a database or a memory unit, from where they can be retrieved for later training of the machine learning model.

In the training step 38, the machine learning model 28 is trained by iteratively presenting a batch of training images 12 to the machine learning model 28 and modifying the parameters of the machine learning model 28 using a loss function. The training step 38 comprises a forward pass step 39 and an update step 41. In the forward pass step 39, the training images are presented to the machine learning model 28. The machine learning model 28 processes the training images and outputs predictions for segmentations. A loss function is then evaluated, which measures the deviation between the predictions of the machine learning model and the annotations provided in the annotation step 35. In the update step 41, the parameters of the machine learning model 28, for example, weights of neural network layers, are updated in order to minimize the value of the loss function. The update step 41 may be performed using a gradient-based optimization method, such as stochastic gradient descent or a variant thereof. The forward pass step 39 and the update step 41 may be iteratively repeated until a predetermined training criterion is met, for example, until the loss function reaches a threshold value or until a maximum number of training epochs is completed.

The formulation of the loss function at at least one pixel depends on the types of annotations 24 at the pixel and on the types of annotations 24 within the batch. Thus, the loss function takes on a specific form if the pixel is part of a complete pixel level annotation 16, whereas the form of the loss function differs if the pixel is part of a subset level annotation 20 or positive image level annotation 22 or negative partial pixel level annotations or negative image level annotation 23, or if the pixel is not part of any annotation. Taking on a specific form here means that the formulation of the loss function depends on the types of annotations present in an image. Complete pixel-level annotations indicate a specific label at each image pixel. Thus, the loss function may be formulated in a pixel-wise manner, as a label deviation can be measured at each pixel. In contrast, for less specific annotations, labels are only known for some of the image pixels and, therefore, the loss function may be formulated in a pixel-wise manner only at these locations. Annotation types that do not indicate specific labels at specific pixels but only for pixel groups such as subset level annotations or image level annotations are not formulated in a pixel-wise manner, but may use operations over respective groups of pixels, e.g., an average, maximum, minimum or pooling operation, and the result of this operation is compared to the annotation. Example formulations of positive associations for different types of annotations within a loss function are given below. The parameters of the machine learning model 28 are modified, e.g., by minimizing the loss function using a variant of gradient descent. The machine learning model 28 is trained for the purpose of being used for semantic image segmentation. In a preferred example, the trained machine learning model 28 is configured to use only images as input.

In an example, the iteratively presented batches of training images 12 are configured such that for each type of annotation 24 a training image 12 exists, such that all other types of the at least three different types of annotations 24 are contained in at least one training image 12 of the preceding training images 12. Thus, training is carried out with training images 12 containing all of the types of annotations 24 within the same training dataset, as opposed to training the machine learning model 28 on a first training dataset containing one or more types of annotations 24 and subsequently training the machine learning model 28 on a second training dataset containing one or more different types of annotations 24.

The loss function for training a machine learning model 28 for semantic image segmentation using at least three different types of annotations 24 can be defined in various ways, which will be explained in the following.

Integrating and combining different annotation types 24 requires modelling dependencies between the pixels of the input image 26 of the machine learning model 28 and the class labels. Let [symbol] denote a training dataset [symbol] ={x₁, . . . , xₙ|xₗ∈R^{W×H×c}^{_{dim}}}, which contains training images x₁, . . . , xₙ of width W, height H and with c_{dim} color or intensity channels. For at least some of the training images x₁, . . . , xₙ at least three types of annotations 24 are provided.

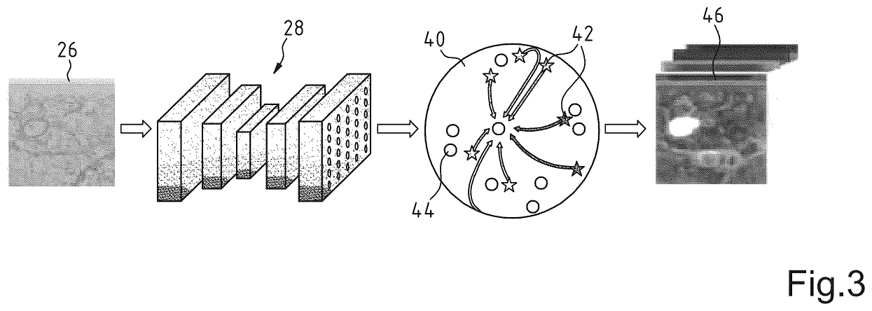

FIG. 3 illustrates the association 46 of pixels in an input image 26 to a class. To efficiently measure the association of a pixel in an input image 26 to a class c∈C, each pixel in the input image 26 is associated with a feature vector referred to as an embedding vector 44 in a feature space 40. To this end, the machine learning model 28 is trained to map each pixel i in an input image 26 to a d-dimensional embedding vector 44, fᵢ∈ [symbol] ^{d}, in a feature space 40. Apart from the pixel itself the neighborhood of the pixel in the input image 26 can be used by the mapping to obtain the embedding vector 44. Any semantic image segmentation network can be modified to yield such an embedding vector 44 for each pixel in the input image 26, e.g., by removing the final classification layer. The association 46 of a pixel of an input image 26 to a class is then measured in this feature space 40.

The association 46 of a pixel in an input image 26 to different classes is measured using characteristic elements 42. Each class is represented by one or more characteristic elements 42. In FIG. 3, the characteristic elements 42 of the same grey value represent the same class. To measure the association 46 of a pixel in an input image 26 to a class c∈C, the similarity of the embedding vector 44 of the pixel in the feature space 40 and one or more characteristic elements 42 of the class in the feature space 40 is measured. The characteristic elements 42 of a class represent typical elements of this class in the feature space 40. The number of characteristic elements 42 for each class can be the same for all classes, or it can be different for some or each of the classes. Preferably, between 1 and 20 characteristic elements 42 are used for each class, more preferably between 1 and 10 characteristic elements 42, most preferably between 1 and 5 characteristic elements 42. All characteristic elements 42 are parameters of the machine learning model 28 and are optimized by minimizing the loss function during the iterations of the training, i.e., they are learned end-to-end during training. In this way, cluster centers are found implicitly without requiring additional knowledge or assumptions or rule-based algorithms. Further assumptions on the characteristic elements 42 can be made, e.g., that they differ from each other or that they are maximally different from each other. By using multiple characteristic elements 42 per class, intra-class variability as well as multi-modal distributions in the learned feature space 40 can be represented.

Let fᵢ indicate the embedding vector 44 of a pixel i of an input image 26 in the feature space 40 and

$${p}_{c}^{j}$$

the j-th characteristic element 42 of a set P_{c} comprising all characteristic elements 42 of class c in the feature space 40. Then the class association 46 of pixel i to class c can, for example, be measured by computing the similarity in the form of the cosine distance between the embedding vector fᵢ and each characteristic element

$${p}_{c}^{j} ∈ {P}_{c}$$

of the class c by

$$σ ( {f}_{i} , {p}_{c}^{j} ) = cos α ( {f}_{i} , {p}_{c}^{j} ) = \frac{{f}_{i}^{⊤} {p}_{c}^{j}}{‖ {f}_{i} ‖ \cdot ‖ {p}_{c}^{j} ‖}$$

and then averaging over all cosine distances for all characteristic elements 42 of the class

$${s}_{c} ( {f}_{i} , {P}_{c} ) = \frac{1}{\vert {P}_{c} \vert} {Σ}_{j ∈ {P}_{c}} σ ( {f}_{i} , {p}_{c}^{j} ) . \qquad ( 1 )$$

This indicates the average similarity between the embedding vector fᵢ of pixel i and the characteristic elements

$${p}_{c}^{j}$$

of class c in the feature space 40, and thus the association 46 of pixel i to class c.

During training, these class associations 46 can be normalized by temperature scaling with τ∈ [symbol] and the softmax function

$$\overline{{s}_{c}} ( {f}_{i} , {P}_{c} ) = \frac{exp ( {s}_{c} ( {f}_{i} , {P}_{c} ) / τ )}{{Σ}_{k = 1}^{C} exp ( {s}_{c} ( {f}_{i} , {P}_{k} ) / τ )} . \qquad ( 2 )$$

The temperature τ is used to scale the associations s_{c}(fᵢ, P_{c}) in order to increase the value range of the cosine similarity above. In this way, the accuracy of the predictions can be improved.

It should be noted that the described integration of semantic knowledge into embedding vectors 44 and characteristic elements 42 can be flexibly used for any complete pixel level annotation 16, positive partial pixel level annotation 18, subset level annotation 20, positive image level annotation 22, negative partial pixel level annotation or negative image level annotation 23, or for any further type of annotation 24 providing semantic cues whether a pixel belongs to a class or not. Due to this flexibility in the type of annotation 24 expert annotators 14 can freely adapt the annotation process to the requirements of the application domain and the specific training images 12 by selecting suitable annotation types.

The class associations 46 can, for example, be used in a cross-entropy loss using complete pixel level annotations 16 or positive partial pixel level annotations 18 to train the machine learning model 28 for semantic image segmentation. At inference time, the class with highest class score is assigned as label l(i) to pixel i

$$l ( i ) = arg {max}_{c} \{ {s}_{c} ( {f}_{i} , {P}_{c} ) \vert c = 1 , … , C \} ,$$

thereby yielding the labeled output image 30.

In the following, the simultaneous handling of various annotation types, in particular of weak annotation types, within a single loss function will be described. Due to the strong variability of the annotation types designing a loss function capable of handling all of the occurring annotation types 24 in the training images 12 at the same time is difficult. To solve this problem, the inventors have come up with the idea of combining the concepts of contrastive learning and multiple-instance learning. In this way, machine learning models 28 can learn from the shared semantics of different annotation types.

Contrastive learning is an unsupervised machine learning technique used to learn the general features of a dataset without annotations by teaching the machine learning model which data points are similar or different. Representations of data points originating from the same but differently perturbed images or from the same class should be similar in the feature space, while all other representations should be different.

Multiple-instance learning is a form of weakly supervised learning where training instances are arranged in sets, called bags, and a class label is provided for the entire bag only instead of each single instance. Negative bags contain only negative instances, while positive bags contain at least one positive instance. This concept can be transferred to weak annotations such as subset level annotations 20 or positive image level annotations 22.

Combining concepts from multiple-instance learning and contrastive learning, thus, allows to handle weak annotation types such as subset level annotations 20 or positive image level annotations 22, while contrastive learning allows to optimize the feature vectors 44 to make them form semantic clusters in the feature space 40.

According to an example of the first embodiment of the invention the loss function comprises a contrastive loss function. A contrastive loss function allows to learn representations of input vectors in a feature space 40 by contrasting between similar and dissimilar input vectors. Similar input vectors are mapped to feature vectors that are close to each other in the feature space 40, whereas dissimilar input vectors are mapped to feature vectors that are far apart in the feature space 40. Usually, the feature space is of lower dimensionality than the input space of the input vectors. Given a set of input vectors and their similarity (X₁,X₂,Y)ⁱ, where (X₁,X₂) denotes a pair of input vectors and Y∈{0,1} indicates if the input vectors X₁ and X₂ are similar (Y=1) or not (Y=0), a contrastive loss function L can be defined as

$$L ( {( {X}_{1} , {X}_{2} , Y )}^{i} ) = ( 1 - Y ) {L}_{s} ( D ( m ( {X}_{1} ) , m ( {X}_{2} ) ) ) + {YL}_{d} ( D ( m ( {X}_{1} ) , m ( {X}_{2} ) ) ) ,$$

where m denotes the mapping into the feature space (the machine learning model 28), Lₛ denotes a loss function applied to similar input vectors, L_{d} denotes a loss function applied to dissimilar input vectors and D denotes a distance measure for two input vectors in the feature space.

For example, contrastive learning encourages that the feature vector of a given input image zₗ and the feature vector of its augmented version [symbol] are similar by minimizing

$$L ( {z}_{l} , \hat{{z}_{l}} ) = - log \frac{exp ( σ ( {z}_{l} , \hat{{z}_{l}} ) / τ )}{{Z}_{l}}$$

with normalization Zₗ computed over a batch size B:

$${Z}_{l} = {Σ}_{j = 1}^{B} exp ( σ ( {z}_{l} , \hat{{z}_{j}} ) / τ ) + exp ( σ ( {z}_{l} , {z}_{j} ) / τ ) .$$

Different from standard contrastive learning, decoupled contrastive learning removes the positive association of the numerator out of the denominator Zₗ to improve the learning efficiency:

$${Z}_{l} = {\sum }_{j = 1 , j \neq l}^{B} exp ( σ ( {z}_{l} , \hat{{z}_{j}} ) / τ ) + exp ( σ ( {z}_{l} , {z}_{j} ) / τ ) .$$

The invention adapts the concept of contrastive learning to semantic image segmentation. Instead of relating feature vectors of augmented training images to each other as described above, embedding vectors fᵢ and classes comprising a set of characteristic elements P_{c} are associated by minimizing the following loss function

$$L ( {f}_{i} , c ) = - log \frac{exp ( {s}_{c} ( {f}_{i} , {P}_{c} ) / τ )}{{z}_{i , c}} = - ( {s}_{c} ( {f}_{i} , {P}_{c} ) / τ ) + log {Z}_{i , c} \qquad ( 3 )$$

with normalization Z_{i,c} with respect to all pixels and batch size B

$${Z}_{i , c} = {\sum }_{j = 1}^{B \cdot H \cdot W} {\sum }_{k = 1 , k \neq c ∧ j \neq i}^{C} exp ( {s}_{k} ( {f}_{j} , {P}_{k} ) / τ ) .$$

The nominator of the loss function enforces the association of fᵢ to characteristic elements in P_{c} to be high, while the denominator attenuates all associations of other embedding vectors fⱼ to characteristic elements in P_{c} and, thus, to class c. This is not desired, as the association between an arbitrary embedding vector fⱼ and the class c represented by the characteristic elements in P_{c} would be decreased during optimization even though pixel j could potentially belong to class c. Therefore, the denominator is modified as follows:

$${Z}_{i , c} = {\sum }_{j = 1}^{B \cdot H \cdot W} {\sum }_{k = 1 , k \neq c ∨ c ∉ {A}_{j}}^{C} exp ( {s}_{k} ( {f}_{j} , {P}_{k} ) / τ ) .$$

Here, Aⱼ denotes the set of all potential class labels at pixel j with respect to the given annotations 24. For example, if j is a pixel in an unannotated training image 32, then the set Aⱼ comprises all classes, since no knowledge about potential classes at pixel j is provided by the annotations 24. If the pixel j belongs to a training image 12 with positive image level annotations 22, Aⱼ comprises all classes of the positive image level annotations 22. Similarly, in a training image 12 containing subset level annotations 20, e.g., bounding boxes, the set Aⱼ contains all classes of subset level annotations 20 containing pixel j. In case of a complete pixel level annotation 16 or a positive partial pixel level annotation 18 the set Aⱼ only contains the class label indicated by the complete pixel level annotation 16 or positive partial pixel level annotation 18 at pixel j.

By utilizing decoupling, all embedding vectors associated with a class c share the same denominator. Thus, the denominators only have to be computed once for each class in a batch, and not for each embedding vector 44. In this way, the computation time is reduced. As Z_{i,c} is independent of pixel i it can be referred to as

$${Z}_{c} = {\sum }_{j = 1}^{B \cdot H \cdot W} {\sum }_{k = 1 , k \neq c ∨ c ∉ {A}_{j}}^{C} exp ( {s}_{k} ( {f}_{j} , {P}_{k} ) / τ ) .$$

Decoupled contrastive learning makes it, thus, possible to associate embedding vectors 44 with learnable characteristic elements 42 of each class and to adjust the characteristic elements 42 in order to form semantic clusters.

By using the contrastive loss function in equation (3) with the denominator Z_{c} above, all associations of other embedding vectors fⱼ to characteristic elements of other classes than class c are attenuated, and all associations of other embedding vectors fⱼ to class c are attenuated, but only if class c does not belong to the potential class labels at pixel j. In this way, embedding vectors 44 of pixels and characteristic elements 42 are only pushed apart by use of the denominator (the contrastive term) if they encode different semantic knowledge. Pixels not belonging to any of the annotations 24 only appear in the denominator of the contrastive loss function, that is in the negative associations.

Thus, according to an example of the first embodiment of the invention, the contrastive loss function is configured such that the association of the pixels of an annotation 24 to the class indicated by the annotation 24 is encouraged, while the associations of pixels outside the annotation 24 to a class are attenuated if the class is different from the class indicated by the annotation 24, or if the class is equal to the class indicated by the annotation 24 but incompatible with the annotations 24 at the pixels outside the annotation.

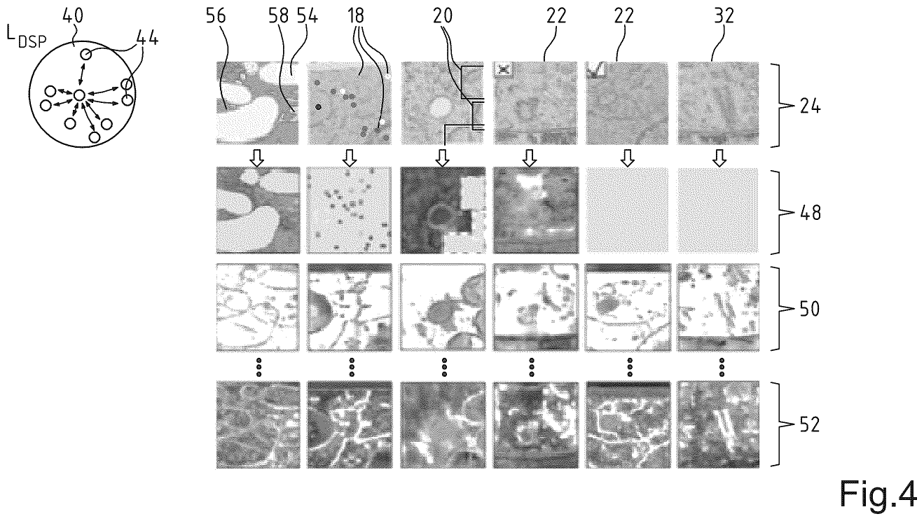

FIG. 4 illustrates the formation of the denominator of the contrastive loss function, the denominator comprising the negative associations for a pixel of a first class 54 for different annotation types. Each column of the first row contains a training image 12 with a different annotation type: a complete pixel level annotation 16 containing class labels of the first class 54, the second class 56 and the third class 58 in the first column, positive partial pixel level annotations 18 in the form of point annotations for all three classes in the second column, subset level annotations 20 for the first class in the third column, a negative image level annotation 23 for a training image 12 not containing the first class 54 in the fourth column, a positive image level annotation 22 for a training image 12 containing the first class 54 in the fifth column, and an unannotated training image 32 in the sixth column. The second row 48 contains negative associations Z₁ for the first class 54 obtained from the corresponding annotations 24 in the first row, that is all associations of pixels to the first class 54 if the first class 54 is incompatible with the annotations at pixel j. For the second column, it is assumed that additional pixels apart from the positive partial pixel level annotations 18 may belong to the first class 54. Thus, only points of positive partial pixel level annotations 18 with class labels different from the first class 54 are part of the negative associations Z₁. For the third column, it is assumed that all pixels belonging to the first class 54 lie within one of the subset level annotations 20, the bounding boxes. Thus, for pixels j outside all bounding boxes the first class 54 is not a potential class label in Aⱼ, so these pixels are part of the negative associations Z₁. For the pixels j within one of the bounding boxes the first class 54 is a potential class label in Aⱼ, so these pixels are not part of the negative associations Z₁ and are set to 0 (grey). For the fourth column, none of the pixels is assigned to the first class 54, thus all pixels of the training image are part of the negative associations Z₁. For the fifth column, all of the pixels can potentially belong to the first class 54, thus none of them is part of the negative associations Z₁. Similarly, for the sixth column no annotations are available and, thus, all pixels can potentially belong to the first class 54. Thus, none of them is part of the negative associations Z₁. The third row 50 contains additional negative associations of Z₁ comprising all associations of pixels to the second class 56. The fourth row 52 contains additional negative associations of Z₁ comprising all associations of pixels to the third class 58. The denominator Z₁ contains the sum of all negative associations contained in the second, third and fourth rows.

In the loss function in equation (3) all positive associations between embedding vectors and classes contribute to the nominator. This can lead to a large number of incorrect associations, e.g., for subset level annotations 20 or positive image level annotations 22, since only a portion of the pixels of the subset level annotation 20 or positive image level annotation 22 is assigned to the indicated class. For example, for a subset level annotation 20 in the form of a rectangular bounding box containing a thin, diagonally oriented object it holds that most of the pixels in the bounding box do not belong to the object and, thus, not to the class indicated by the bounding box. Thus, using all embedding vectors 44 for all pixels within the bounding box as positive associations in the nominator would introduce a lot of noise due to incorrect class associations. Thus, positive annotations have to be carefully selected and designed with respect to the specific type of annotation and its information content. According to an example of the first embodiment of the invention, the way the association of the pixels of an annotation 24 to the class indicated by the annotation 24 is encouraged, therefore, depends on the type of the annotation 24.

The inventors found that the definition of positive associations in the nominator of equation (3) with respect to the different annotation types can be defined using multiple-instance learning by selecting suitable pooling functions for each annotation type.

The contrastive loss function in equation (3) is, thus, reformulated as follows to handle different annotation types

$$L = {\sum }_{t ∈ T} {\sum }_{c ∈ C} ( - {s}_{pos} ( {Ω}_{c}^{t} ) + {s}_{neg} ( {Ω}_{c}^{t} ) ) ,$$

$$where$$

$${s}_{neg} ( {Ω}_{c}^{t} ) = log {Z}_{c} = log ( {\sum }_{j = 1}^{B \cdot H \cdot W} {\sum }_{k = 1 , k \neq c ∨ c ∉ {A}_{j}}^{C} {s}_{k} ( {f}_{j} , {P}_{k} ) ) .$$

Here, t∈T indicates the type t of an annotation

$${Ω}_{c}^{t}$$

from a set T of annotation types. For example, T={m, pp, s, pim, np, nim} can indicate the types m: complete pixel level annotations (masks), pp: positive partial pixel level annotations, s: subset level annotations, pim: positive image level annotations, np: negative partial pixel level annotations, nim: negative image level annotations.

$${Ω}_{c}^{t}$$

indicates an annotation of type t for indicated class c. c∈C indicates the class c of a set of classes C. The contrastive loss function comprises a sum of positive associations sₚₒₛ and negative associations s_{neg}, wherein

$${s}_{pos} ( {Ω}_{c}^{t} )$$

indicates the association of the pixels in annotation

$${Ω}_{c}^{t}$$

of type t to class c, and

$${s}_{neg} ( {Ω}_{c}^{t} )$$

indicates the negative associations comprising the similarity sₖ(j, Pₖ) of a pixel j to class k, wherein Aⱼ indicates the set of classes compatible with pixel j with respect to the annotations at pixel j. The function sₖ can, for example, be defined as in equation (1). Different similarity functions can be used as well. By minimizing the loss function the positive associations are increased, whereas the negative associations are minimized.

In case of a complete pixel level annotation 16, the positive association of each pixel of the annotation 24 to the indicated class and, thus, the association of the corresponding embedding vectors 44 to the characteristic elements 42 of the indicated class is known precisely. Thus, for example, to represent the association of an instance (i.e., a connected component in the complete pixel level annotation 16) to the class indicated by the complete pixel level annotation 16 all associations within the instance are averaged

$${s}_{pos} ( {Ω}_{c}^{m} ) = \frac{1}{\vert {Ω}_{c}^{m} \vert} {\sum }_{i ∈ {Ω}_{c}^{m}} {s}_{c} ( {f}_{i} , {P}_{c} ) ,$$

wherein the associations s_{c} to class c can be computed using equation (1). This averaged association of the instance to the indicated class then serves as positive association in the contrastive loss function.

In case of a positive partial pixel level annotation 18, the association of each pixel of the positive partial pixel level annotation 18 to the indicated class is also known. Thus, each embedding vector 44 of a pixel within the positive partial pixel level annotation 18 is used as a positive association in the contrastive loss function above

$${s}_{pos} ( {Ω}_{c}^{pp} ) = {\sum }_{i ∈ {Ω}_{c}^{pp}} {s}_{c} ( {f}_{i} , {P}_{c} ) .$$

In case of a subset level annotation 20, the association of the pixels of a subset level annotation 20 to the class indicated by the subset level annotation 20 can comprise a function of one or more line-wise and/or row-wise maxima of the associations of the pixels of the subset level annotation 20 to the class indicated by the subset level annotation 20. Assumptions can be made to formulate the positive associations sₚₒₛ. For example, a property of a bounding box can be that in each vertical and each horizontal line of pixels within the bounding box at least one pixel belongs to the class indicated by the bounding box. This property can be used to formulate the positive associations for a bounding box by taking the sum over the maximum associations within each row and column of the bounding box

$${s}_{pos} ( {Ω}_{c}^{s} ) = {\sum }_{x = 1}^{w} {max}_{y ∈ \{ 1 , … , h \}} {s}_{c} ( {f}_{x , y} , {P}_{c} ) + {\sum }_{y = 1}^{h} {max}_{x ∈ \{ 1 , … , w \}} {s}_{c} ( {f}_{x , y} , {P}_{c} ) .$$

Here, w and h indicate the width and height of the bounding box, and f_{x,y} indicates the embedding vector of the pixel at position (x,y) within the bounding box. Alternatively, only the row-wise or column-wise maxima can be used to formulate the positive associations. Alternatively, the associations within a subset level annotation 20 can be averaged. Alternatively, the associations within a subset level annotation 20 can be weighted depending on the location within the subset, e.g., higher weights can be assigned to associations closer to the center of the subset.

In case of a positive image level annotation 22 the association of the pixels of the positive image level annotation 22 to the class indicated by the positive image level annotation 22 can comprise the average of all associations of the pixels of the positive image level annotation 22 to the class indicated by the positive image level annotation 22

$${s}_{pos} ( {Ω}_{c}^{pim} ) = \frac{1}{\vert {Ω}_{c}^{pim} \vert} {\sum }_{i ∈ {Ω}_{c}^{pim}} {s}_{c} ( {f}_{i} , {P}_{c} ) .$$

In case of a negative pixel level annotation, the respective associations are added to the negative associations

$${s}_{neg} ( {Ω}_{c}^{np} ) = {\sum }_{i ∈ {Ω}_{c}^{np}} {s}_{c} ( {f}_{i} , {P}_{c} ) .$$

In case of a negative image level annotation, the respective associations are added to the negative associations

$${s}_{neg} ( {Ω}_{c}^{nim} ) = {\sum }_{i ∈ {Ω}_{c}^{nim}} {s}_{c} ( {f}_{i} , {P}_{c} ) .$$

In case of further annotation types similar pooling functions can be derived depending on the information content of the annotation types to define the positive associations sₚₒₛ or negative associations s_{neg}.

Pixels that do not belong to any annotation 24 only appear in the denominator of the remaining terms. Thus, information on the class association for these pixels is indirectly derived from the annotations 24 at other pixels. Instead of s, other similarity functions can be used.

According to an example of the first embodiment of the invention, the association of the pixels of an annotation 24 to the class indicated by the annotation 24 in the contrastive loss function is weighted by a weighting factor depending on the type of the annotation. The weighting factor can, for example, depend on the specificity of the annotation type. Complete pixel level annotations 16 or positive partial pixel level annotations 18 come with a high specificity, since each pixel within the annotation is unambiguously assigned to the indicated class. The specificity of a subset level annotation 20 is lower, since the indicated class label is only present at a certain amount of pixels within the subset, e.g., within each row and column of a bounding box. The specificity of a positive image level annotation 22 is lowest, since the indicated class label can be present at only a single pixel within the training image 12. The specificity of a negative image level annotation 23 and a negative partial pixel level annotation is lower than that of a positive partial pixel level annotation 18 but higher than that of a positive image level annotation 22 and a subset level annotation 20, since they forbid a class label for each pixel within the annotation. The higher the specificity of the annotation 24 the larger the weighting factor can be selected. Alternatively, the weighting factor can depend on the information content of the type of annotation. The information content measures the value of information that can be gained from the annotation type for the training of the machine learning model, e.g., the number of pixels about which the annotation makes a statement. For example, the information content of a complete pixel level annotation 16 is usually high, since it usually comprises a large number of pixels assigned to the indicated class. It can be measured by the number of pixels assigned to the indicated class. In contrast, the information content of a positive partial pixel level annotation 18 comprising only a single or a few pixels is low, since information is only available for a small amount of pixels. Similarly, the information content of a subset level annotation 20 and a positive image level annotation 22 is 1, since only a single pixel of the annotation must be assigned to the indicated class label. To incorporate negative annotations, the information content can also consider the number of potential class labels assigned by the annotation. The information content of a negative partial pixel level annotation can, for example, be defined by

$$\frac{\vert {Ω}_{c}^{np} \vert}{( C - 1 )} ,$$

and the information content of a negative image level annotation 23 can, for example, be defined by

$$\frac{W \cdot H}{( C - 1 )}$$

(or by

$$\frac{W \cdot H \cdot D}{( C - 1 )}$$

in case of image stacks or volumes).

The concepts of specificity and information content can be combined, e.g., by multiplying them.

According to an example of the first embodiment of the invention, the contrastive loss function considering weighted types of annotations 24 can be of the form

$${L}_{DSP} = {\sum }_{t ∈ T} {λ}_{t} {\sum }_{c ∈ C} ( - {s}_{pos} ( {Ω}_{c}^{t} ) + {s}_{neg} ( {Ω}_{c}^{t} ) )$$

$${s}_{neg} ( {Ω}_{c}^{t} ) = log {Z}_{c} = log ( {\sum }_{j = 1}^{B \cdot H \cdot W} {\sum }_{k = 1 , k \neq c ⋁ c ∉ {A}_{j}}^{C} {s}_{k} ( {f}_{j} , {P}_{k} ) ) .$$

Here, λₜ indicates a weighting factor for annotations of type t, which controls the influence of an annotation type on the loss function. The weighting factors can all be set to the same value or to different values. To remove weighting, the weighting factors can be set to 1. The loss function is referred to as decoupled contrastive loss function (L_{DSP}) in the following.

Instead of weighting each type of annotation, each annotation 24 can be weighted by a weighting factor. The weighting factor can, for example, depend on the number of pixels contained in the annotation 24. For example, a large subset level annotation 20 is less informative for the training than a small subset level annotation 20. Thus, smaller subset level annotations 20 can be accorded a higher weighting factor. A large complete pixel level annotation 16 is more informative for the training than a small complete pixel level annotation 16 or a positive partial pixel level annotation 18. Thus, a larger weighting factor can be accorded to the larger complete pixel level annotation. In this case, weighting factors λ_{tc} can be introduced into the loss function L_{DSP} above.

Another way of integrating different annotation types into a loss function is by using augmented training images with pseudo-annotations, which are filtered depending on the annotation types. Both ways, the annotation dependent contrastive loss function and the pseudo-annotation filtering can be used separately or in combination.

Training image augmentation is a common technique in machine learning aimed at automatically increasing the amount of training data and preventing overfitting of the machine learning model 28. To this end, the training images 12 are modified using image processing operations, e.g., rotation, translation, flipping, changes in contrast, brightness or hue, by setting subsets of the image to a specific value (e.g., cut-outs) or by other pixel modifications, etc. The modified training images 12 are termed augmented training images.

For supervised or semi-supervised training of machine learning models the amount of training data can be increased automatically by generating pseudo-annotations for unannotated training images 32. Pseudo-annotations can be generated during training by presenting an unannotated training image 32 to the machine learning model 28, e.g., the neural network, and obtaining class label predictions. From the class label predictions at each pixel pseudo-annotations can be obtained in different ways. For example, the class label with the highest probability at each pixel can be assigned to the pixel, thereby generating a pseudo complete pixel level annotation. In another example, a class label occurring in the predictions for a subset of the unannotated training image 32 can be assigned to the subset, thereby generating a pseudo subset level annotation. For example, a class label occurring in any of the predictions for pixels in the unannotated training image 32 can be assigned to the unannotated training image 32, thereby generating a pseudo positive image level annotation. Rules can be applied to the pseudo-annotation generation, e.g., that pseudo-annotations are only generated if the confidence in the prediction is sufficiently high. For example, a pseudo-annotation for a class label is only generated if the likelihood for the predicted class label lies above a threshold, or if the likelihood for the predicted class label is significantly higher than the likelihood for the other predicted class labels. For example, a pseudo-annotation for a subset or for the whole training image is only generated if the share of predicted class labels for the pixels within the subset or training image lies above a threshold, or if it is significantly higher than the share of the other class labels. Other rules can be derived with respect to morphological properties of pseudo-annotations such as size, area, eccentricity, ellipticity, elongation, perimeter, moments, centroid, location, etc., exceeding, e.g., a morphological property, exceeding a specific value or lying below a specific value.

The concept of training image augmentation and pseudo-annotation generation can be combined, e.g., by first generating pseudo-annotations for an unannotated training image 32 and then augmenting the unannotated training image 32 and transferring the generated pseudo-annotations to the augmented training image. However, the use of pseudo-annotations easily introduces incorrect annotations 24, which are then used for training. Thus, the inventors had the idea to leverage the information contained in weak annotations, i.e., positive partial pixel level annotations 18, subset level annotation 20 or positive image level annotations 22, to filter the generated pseudo-annotations in order to remove the pseudo-annotations contradicting the weak annotations.

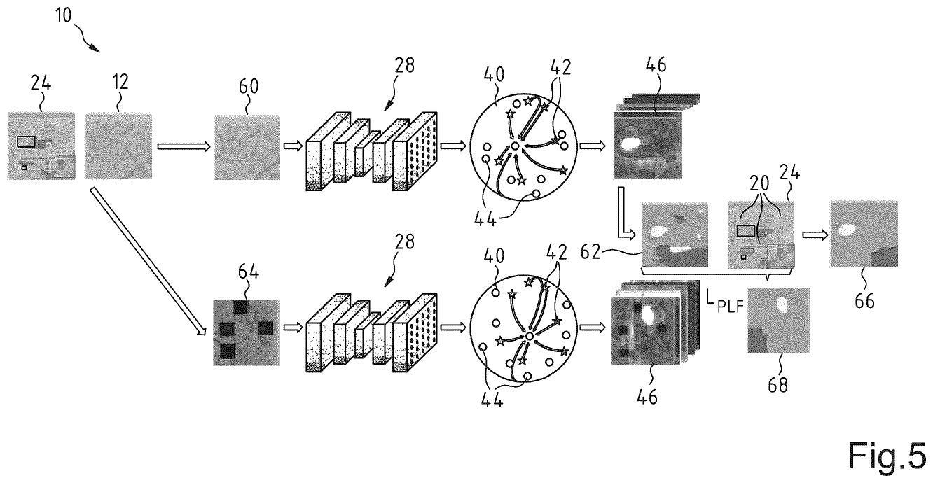

FIG. 5 illustrates a computer implemented method 10 for training a machine learning model 28 for semantic image segmentation according to an example of the first embodiment of the invention. The method comprises using augmented training images 60 with pseudo-annotations 62 during training of the machine learning model 28 in order to extend the available training data and to regularize the machine learning model 28 to obtain invariance of the machine learning model 28 towards image augmentations. Augmented training images 60 can be generated as described above by applying, e.g., image processing transformations to training images 12, in particular to training images 12 comprising annotations 24, e.g., weak annotations. Then each augmented training image 60 is presented to the machine learning model 28 to obtain embedding vectors 44 for each pixel in the feature space 40. Associations 46 to class labels are then obtained with respect to the similarity of each embedding vector 44 to the characteristic elements 42 associated with each class, e.g., using equation (1). The class label with the highest similarity value is assigned to the pixel, thus yielding pseudo-annotations 62 in the form of complete pixel level annotations 16. Other types of annotations 24, e.g., subset level annotations 20 or image level annotations 22, can be generated as well from the pseudo-annotation 62 as described above. By using the annotations 24, the subset level annotations 20 in this case, provided for the original training image 12 underlying the augmented training image 60, the pseudo-annotations 62 can be filtered yielding filtered pseudo-annotations 66. Pseudo-annotation filtering can work as follows: in case of indicated positive image level annotations 22 for the training image 12, all pseudo-annotations 62 with class labels not contained in the class labels of the positive image level annotations 22 can be filtered, i.e., removed. In case of subset level annotations 20 for a class label all pseudo-annotations 62 for the class label lying outside of all subset level annotations 20 for this class label can be filtered, i.e., removed. In case of complete pixel level annotations 16 or positive partial pixel level annotations 18 for the training image 12, all pseudo-annotations 62 contradicting these complete pixel level annotations 16 or positive partial pixel level annotations 18 can be filtered, i.e., removed. For example, in FIG. 5 the training image 12 comprises subset level annotations 20 in the form of bounding boxes. Assuming that all instances of the respective object are contained in any of the indicated bounding boxes, all pseudo-annotations 62 for the respective class label lying outside the bounding boxes are incompatible with the bounding boxes and, thus, filtered.

To filter pseudo-annotations 62, the loss function can be configured to filter the pseudo-annotations 62 by preventing the association 46 of a pixel in an augmented training image 60 to the class indicated by the pseudo-annotation 62 at that pixel, if the pseudo-annotation 62 is not compatible with an annotation 24 at the corresponding pixel in the training image 12 underlying the augmented training image 60. For example, a cross entropy loss function can be set to oo for associating the pseudo-annotation pixels with the pseudo-annotation class in case of incompatibility with the annotations 24, e.g., by setting the relevant pre-softmax scores in equation (2), i.e., the value of the function s, in equation (1) to −∞. In case of a complete pixel level annotation 16 or positive partial pixel level annotation 18 in the training image 12, the loss function can be set to −∞ or 0 for associating corresponding pseudo-annotation pixels with the class indicated by the complete pixel level annotation 16 or positive partial pixel level annotation 18 in the training image 12. Instead of modifying the loss function, the indicated class labels of the pseudo-annotations 62 can be directly modified.

According to an aspect of the example of the first embodiment of the invention, the augmented training images 60 are obtained by applying one or more image processing operations from the group comprising flipping, rotation, translation, contrast variation, brightness variation, saturation variation and hue variation to the training images 12. In particular, horizontal and vertical flipping, rotations by 0, 90, 180 or 270 degrees, and contrast, brightness, saturation and hue variations by a factor of 0.2 can be used. In addition, for each augmented training image 60 one or more strongly augmented training images 64 are obtained by applying one or more arbitrary image processing operations to the corresponding training image 12. These arbitrary image processing operations can comprise the image processing operations from the group applied to obtain the augmented images 60 for the same and/or different parameters and additional image processing operations, e.g., masking subsets of the corresponding training image 12 by setting them to 0 (cut-out) or explicitly modifying pixel values of the corresponding training image 12, etc.

In FIG. 5, the strongly augmented training image 64 is obtained by a clockwise 90 degree rotation, brightness reduction and masking of several rectangular subsets of the training image 12. For the strongly augmented training image 64 class associations 46 are obtained by presenting the strongly augmented training image 64 to the machine learning model 28. The loss function of the machine learning model can be configured to filter the pseudo-annotations 62 of the augmented training image 60 yielding filtered pseudo-annotations 66. The loss function can comprise a deviation of the class associations 46 obtained by presenting the strongly augmented training image 64 to the machine learning model 28 from the filtered pseudo-annotations 66 obtained by filtering the class associations 46 computed for the corresponding augmented training image 60. The filtered pseudo-annotations 66 are transferred to the strongly augmented training image 64, e.g., by use of rotation or translation yielding transferred filtered pseudo-annotations 68. The loss function can, for example, be formulated as a cross entropy loss function to minimize the deviation of the class associations 46 and the transferred filtered pseudo-annotations 68 for the strongly augmented training image 64. After pseudo-label filtering, class labels for each pixel are obtained by taking the argmax over the class associations for all classes. The pseudo-annotation based cross entropy loss function between the class associations 46 on the strongly augmented training images 64 and the transferred filtered pseudo-annotations 68 is referred to as L_{PLF} in the following.

According to an example of the first embodiment of the invention, the loss function comprises a cross entropy loss function for pixels of complete pixel level annotations 16 or positive partial pixel level annotations 18

$${L}_{C E} = - {\sum }_{c = 1}^{C} {\sum }_{i ∈ {Ω}_{c}^{m} ⋁ i ∈ {Ω}_{c}^{pp}} {t}_{c} ( i ) log ( {p}_{c} ( i ) ) ,$$

where t_{c}(i) indicates the true label at pixel i and p_{c}(i) the probability of pixel i being associated with class c. The probability of pixel i being associated with class c, p_{c}(i), can, for example, be calculated from the scaled normalized class associations in equation (2).

The three loss functions defined above L_{DSP}, L_{PLF}, L_{CE} can be used together, separately or in any combination of two of them, e.g.,

$$L = {L}_{DSP} + {L}_{PLF} or L = {L}_{DSP} + {L}_{CE} or L = {L}_{PLF} + {L}_{CE} or L = {L}_{DSP} + {L}_{PLF} + {L}_{CE} .$$

According to an example of the first embodiment of the invention, the method 10 for training a machine learning model 28 for semantic image segmentation further comprises retraining the machine learning model 28 on a subset of the training images 12 comprising more specific annotations 24. The specificity of an annotation 24 can, for example, be measured by the portion of pixels within the annotation that is at least assigned (or not assigned in case of negative annotations) to the class label indicated by the annotation 24. The higher the portion is the more specific is the annotation 24. For example, complete pixel level annotations 16 and positive partial pixel level annotations 18 assign the corresponding class label to each of their pixels. Thus, the portion of pixels within these annotations 16, 18 that are assigned to the class label is 1, indicating the highest possible specificity. The specificity of a subset level annotation

$${Ω}_{i}^{s}$$

depends on the size of the subset and is

$$\frac{1}{\vert {Ω}_{i}^{s} \vert} .$$

The specificity of a positive image level annotation

$${Ω}_{i}^{p i m}$$

depends on the image size and is

$$\frac{1}{\vert {Ω}_{i}^{p i m} \vert} = \frac{1}{W \times H}$$

(respectively

$$\frac{1}{W \times H \times D}$$

for image stacks or volumes). To incorporate negative pixel level annotations and negative image level annotations 23, the specificity can include the number of potential class labels assigned, i.e., C−1 in case of negative pixel level annotations and negative image level annotations 23. For example, the specificity can be multiplied by 1 over the number of potential class labels assigned to the respective pixels. For negative partial pixel level annotations and negative image level annotations 23 the specificity would then be

$$\frac{1}{C - 1} \cdot 1 ,$$

since both annotations forbid a class label at each pixel in the annotation the specificity of a positive image level annotation 22 in a training image 12 can be increased by adding one or more subset level annotations 20 or one or more complete pixel level annotations 16 or one or more positive partial pixel level annotations 18 with the same class label to the training image 12. The specificity of a subset level annotation 20 in a training image 12 is increased by adding one or more positive partial pixel level annotations 18 with the same class label within the subset in the training image 12. Likewise, the specificity of an annotation 24 can be decreased during training as described above.

The formulation of the loss function in (4), in particular of the term L_{DSP} defined above, depends on the types of annotations at a pixel and on the types of annotations within a batch. Depending on the type t of annotation, a different positive (or negative) association is selected within the term L_{DSP}. In addition, the negative associations Z_{c} in the term L_{DSP} depend only on the current batch B. Thus, the formulation of the loss function term L_{DSP} and, thus, the loss function itself, depends on the types of annotations present in an image and on the current batch.

Each annotation type assigns pixel classes in different ways, and the other examples within the batch serve to differentiate these pixel classes from other classes, thereby enabling contrastive learning. The loss function, thus, contrasts some samples (positive associations) with other samples of the batch (negative associations). The loss function is, thus, a contrastive loss function.

Instead of directly mapping pixels to classes, the machine learning model may be trained by minimizing the contrastive loss function to learn a pixelwise mapping to a feature space for semantic image segmentation. In this case, the loss function operates on embedding vectors in the feature space. Instead of mapping a pixel in an input image directly to a label, the machine learning model maps the pixel to an embedding vector in the feature space. The feature space can then be used to associate pixels to class labels based on their embedding vectors in the feature space. Class associations in the feature space can, for example, be established based on the distance of an embedding vector of a pixel and one or more characteristic elements (prototypes) of each class in the feature space. The class associations are expressed by the functions s_{c}(fᵢ, P_{c}) and sₖ(fⱼ, Pₖ) in the loss function. Thus, class labels are derived from distances of the embedding vectors to characteristic elements in the feature space. The machine learning model is, thus, configured to map pixels of an input image to embedding vectors in a feature space for semantic image segmentation, where class associations are encoded by distances to characteristic elements of the classes. Using class associations in a feature space via distances to characteristic elements (prototypes) simplifies the segmentation task and allows for more accurate segmentation results, since various characteristic elements may belong to the same class. Thus, multivariate classes with different appearances can be implemented in this way without difficulty.

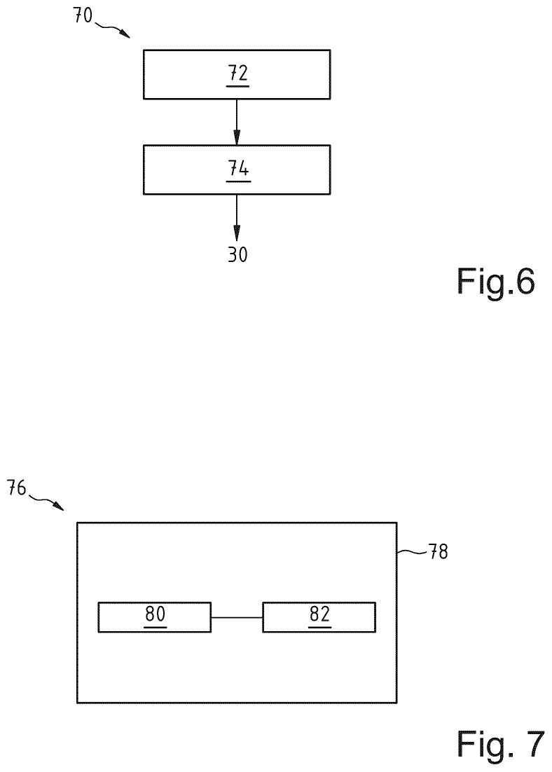

FIG. 6 shows a flowchart of a computer implemented method 70 for semantic image segmentation according to a second embodiment of the invention. The method comprises obtaining an image in an imaging step 72 and applying a machine learning model 28 trained using a method according to the first embodiment of the invention to the obtained image to obtain a semantic image segmentation 30 in a machine learning model application step 74.

FIG. 7 illustrates a data processing apparatus 76 according to a third embodiment of the invention, which is configured for carrying out a computer implemented method 10 according to the first embodiment of the invention. The data processing apparatus 76 comprises a training unit 78 comprising one or more processing devices 80, e.g., a central processing unit (CPU), graphics processing unit (GPU), or tensor processing unit (TPU), and one or more hardware storage devices 82. The one or more hardware storage devices 82 comprise training images 12 with corresponding annotations 24 of at least three different annotation types and instructions that are executable by one or more processing devices 80 to carry out a method according to the first embodiment of the invention.

In some implementations, each processing device 80 can include one or more processor cores, and each processor core can include logic circuitry for processing data. For example, a processing device can include an arithmetic and logic unit (ALU), a control unit, and various registers. Each processing device can include cache memory. Each processing device can include a system-on-chip (SoC) that includes multiple processor cores, random access memory, graphics processing units, one or more controllers, and one or more communication modules. Each processing device can include a combination of, e.g., CPUs, GPUs, (and/or TPUs), neural engines, a memory system, image signal processors, storage controllers, and communication units. Each processing device can include millions or billions of transistors. Each hardware storage device 82 can include, e.g., one or more of random access memory (RAM), read-only memory (ROM), erasable programmable read-only memory (EPROM), electrically erasable programmable read-only memory (EEPROM), flash storage device, solid state drive, magnetic disk, internal hard disk, removable disk, magneto-optical disk, CD-ROM, DVD-ROM, or Blu-ray disc.

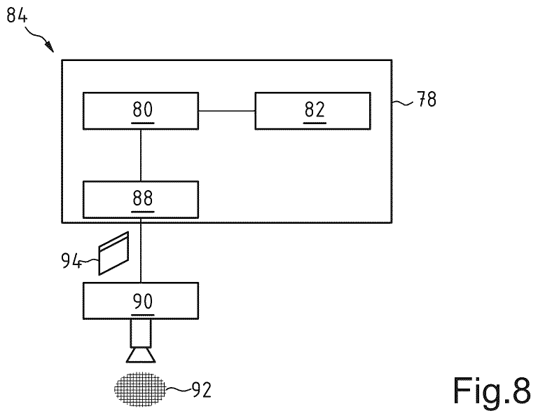

FIG. 8 illustrates a system 84 for semantic image segmentation, the system 84 comprising an imaging device 90 configured to provide an image 94 of a scene 92 or object, e.g., from an expert application domain, an interface 88, one or more processing devices 80, e.g., a CPU or a GPU, one or more machine-readable hardware storage devices 82 comprising a machine learning model 28 trained according to a computer implemented method 10 of the first embodiment of the invention and instructions that are executable by one or more processing devices 80 to apply the trained machine learning model 28 to the image 94 of the scene 92 or object. The imaging device 90 can be any apparatus described above that can generate images. The imaging device 90 can include one or more image sensors, such as charge coupled device (CCD) or complementary metal oxide semiconductor (CMOS) sensors. Each sensor can include an array of independently addressable pixels or sensing elements.

In the following, experimental results are shown using various types of annotations 24 and the loss function in equation (4). The results confirm that accurate predictions can be made even if the machine learning model is trained with only a very small amount of training data. Thus, by using the loss function in (4) and various types of annotations 24 the amount of training data required for training a machine learning model 28 for semantic image segmentation is reduced. In addition, the results show that the trained machine learning models 28 outperform state of the art semantic image segmentation machine learning models, in particular for small amounts of training data.

For training images including annotations 24, the accuracy of the trained machine learning model with respect to the amount of annotations 24 is of interest. The amount of annotations 24 can be measured in terms of the annotation compression ratio (ACR). For each annotation type t the annotation compression ratio ACRₜ can be defined as

$${ACR}_{t} = \frac{\#available annotations of type t}{\#used annotations of type t} .$$

The larger the ACRₜ for an annotation type the less annotations are used for training of the machine learning model 28. For example, a machine learning model 28 trained with an ACRₜ=2 uses only half of the available annotations 24 of type t during training. The ACR over all types of annotations can be defined as

$$ACR = {\sum }_{t ∈ T} {ACR}_{t} cost ( t ) .$$

This formulation of the ACR reflects different costs for different types of annotations, e.g., the cost of a complete pixel level annotation may be 1, the cost of a subset annotation may be 1/10, the cost of a positive image level annotation may be 1/100, and the cost of a positive partial pixel level annotation may be 1/50 or depend on the number of pixels within the annotation. Thus, the highest compression can be achieved by reducing the amount of complete pixel level annotations 16, while the lowest compression can be achieved by reducing the amount of positive image level annotations 22. Alternatively, the costs can be selected according to the specificity or to the information content of the annotation 24. Alternatively, costs can be disregarded by setting cost(t)=1 for each annotation type t.

For analyzing the efficiency of a training algorithm for semantic segmentation models, the accuracy of the trained machine learning models is indicated with respect to increasing ACRs. The ACR values are exponentially sampled, i.e., subsequently cutting the number of used annotations 24 in half.

The accuracy of the machine learning models is measured using the DICE score. The DICE score for a class label c is defined by comparing the areas of the ground truth segmentation T_{c} for the class label and the area of the predicted segmentation P_{c} for the class label

$${DICE}_{c} = \frac{2 \vert {T}_{c} ⋂ {P}_{c} \vert}{\vert {T}_{c} ⋃ {P}_{c} \vert} .$$

The DICE score for a semantic image segmentation can then be defined as the average DICE score over all class labels c appearing in the semantic image segmentation.

The machine learning models for semantic image segmentation were evaluated on the OPENORGANELLE data collection with focus on the four datasets HELA-2, HELA-3, JURKAT-1, MACROPHAGE-2.

These datasets are large tissue volumes scanned with focused ion beam scanning electron microscopes (FIB-SEM) and come with annotated sub-volumes. The segmentation task was to segment cell organelles in these sub-volumes, which are processed as 2D slices. For a statistically sound analysis, cross-validation splits were created via cross-sub-volume train/validation/test splits under the side-condition that every class is present in at least one sub-volume per split. However, since many of the OPENORGANELLE classes are highly specialized, this condition is rarely fulfilled. Therefore, the classes were merged into 17 classes following a biologically consistent class-hierarchy (e.g., merging mitochondria, mitochondria membrane and mitochondria DNA). Rare classes occurring in less than three sub-volumes were excluded due to the requirement for cross-sub-volume validation. This resulted in 11 classes for HELA-2, 10 classes for HELA-3, and 8 classes for JURKAT-1 and MACROPHAGE-2. In total, 10 cross-validation splits were obtained for the largest dataset HELA-2 and 5 for the remaining ones. Each split was randomly shuffled, with the exception that all C classes had to be present in the first C images. Finally, it was made sure that the annotated images for small ACRs contained all annotations of larger ACRs.

The trained machine learning models 28 are implemented with the same Unet architecture with successive feature-map channel sizes of {64, 128, 256, 512, 1024} in the encoder and the corresponding reversed order of channel sizes in the decoder. This results in a versatile and yet efficient network with about 22 million trainable parameters. It is to be noted that all semantic image segmentation methods disclosed herein are applicable to other segmentation architectures as well, for example to convolutional neural network based encoder-decoder architectures (SegNet, DeepLab family, ENet, etc.), to Transformer-based architectures (SegFormer, Vision Transformer, Mask2Former, etc.), fully convolutional neural networks, conditional random fields or graph-based segmentation networks, etc. The machine learning models 28 were trained using AdamW using β₁=0.9, β₂=0.999, a learning rate of 6e⁻⁵, a weight decay equal to 0.01 and Xavier initialization. The trainings were carried out in a multi-GPU setup with 4 times 40 GB NVIDIA A100-40 for 100 epochs on each split. For each split, validation is carried out every 10 epochs, and each val-best model was evaluated on the corresponding test set after training.

As different training methods have different memory requirements, the batch size B was always set to the maximally possible size under the method's memory consumption (between 16 and 28). Batching required equally-sized inputs, but the datasets have varying image sizes. Thus, all training images 12 were zero-padded to the respective maximal image size.

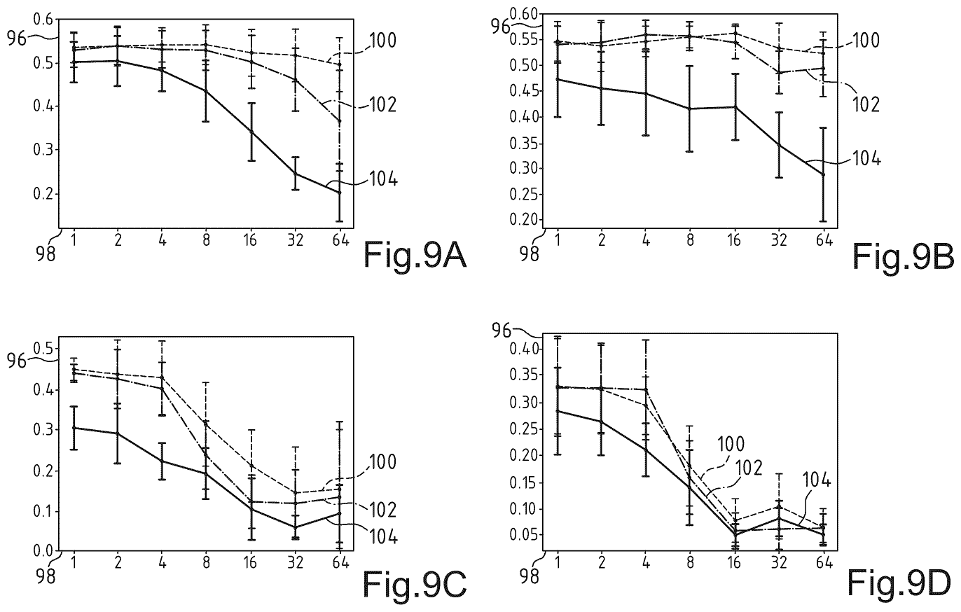

FIGS. 9A to 9D illustrate the accuracy of the trained machine learning models for decreasing amounts of annotations 24 on the OPENORGANELLE collection in the expert application domain of biology. The annotations 24 comprise at least three different types of annotations 24. FIG. 9A shows results for the HELA-2 dataset, FIG. 9B for the HELA-3 dataset, FIG. 9C for the MACROPHAGE dataset and FIG. 9D for the JURKAT-1 dataset. On the vertical axis 96 the mean DICE score and the standard deviation are indicated over all classes occurring in the respective dataset. On the horizontal axis 98 the ACR is indicated. The accuracy measured by the mean DICE score is compared for a first machine learning model 100 according to the second embodiment of the invention trained using the loss function in (4), for a second machine learning model 102 according to the second embodiment of the invention trained using pseudo-annotation filtering and FixMatch and for a basic Unet machine learning model 104 trained using a cross entropy loss function L_{CE}. For the first machine learning model 100, embedding vectors 44 were obtained by replacing the final classification layer of a Unet machine learning model with a sequence of batch norm, 1×1 convolutions with 64 kernels, LeakyReLU and final 1×1 convolutions with 64 kernels. This replacement generates 64 dimensional embedding vectors 44. Five characteristic elements were used per class |P_{c}|=5, and the temperature z was set to 0.05. The weights for the annotation types were set to λₘ=λₚₚ=λₛ=λₚᵢₘ=0.1. The basic Unet machine learning model 104 was trained using a cross entropy loss function L_{CE} from only complete pixel level annotations 16 as a baseline. The results on all four datasets show that the accuracy of the trained machine learning models generally decreases with increasing ACR, that is with less annotations 24 used during training. However, the accuracy of the first machine learning model 100 is higher than the accuracy of the second machine learning model 102 and of the basic Unet machine learning model 104 for almost all ACRs. For the HELA-2 and HELA-3 datasets in FIGS. 9A and 9B, at an ACR=64 with merely 1.6% pixel level annotations (less than 40) the accuracy of the first machine learning model 100 still yields a mean DICE score of 49.5%, which is comparable to the mean DICE score of 50.1% of the basic Unet in case of full supervision for an ACR=1. Compared to the second machine learning model 102 the accuracy of the first machine learning model 100 is improved by 12.8%.

Compared to scenarios with less than three types of annotations, the accuracy of the first machine learning model 100 for semantic image segmentation is improved. Thus, using diverse (including less specific) types of annotations improves the accuracy of semantic image segmentation. This is due to the reason that less specific types of annotations such as positive partial pixel level annotations 18, subset level annotations 20 or positive image level annotations 22 contain meta information that are not provided by complete pixel level annotations, e.g., central or specifically important points are indicated by positive partial pixel level annotations 18 such as scribbles, the spatial extent of an object is indicated by subset level annotations 20 such as bounding boxes, or the most prominent or relevant types of objects in a training image 12 are indicated by positive image level annotations 22.

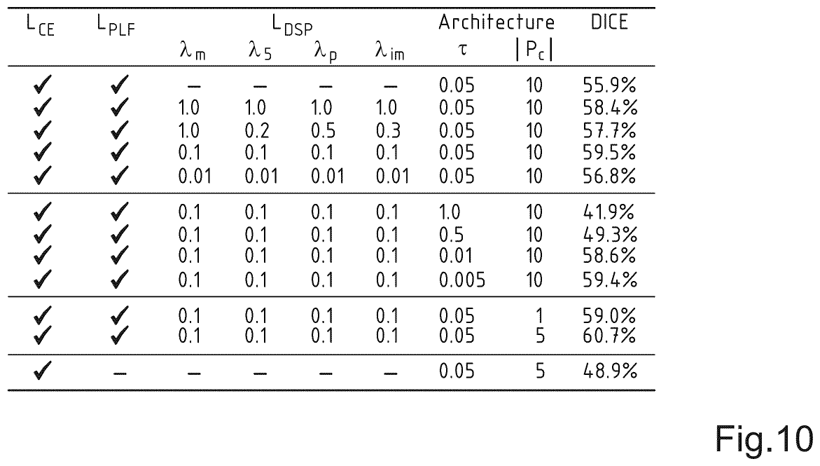

FIG. 10 shows ablation studies illustrating the sensitivity of the trained machine learning model according to the first embodiment of the invention with respect to selected parameters. The machine learning model according to the first embodiment of the invention was trained on the first split of the HELA-2 dataset with at least three annotation types. The results in the first row of the table show that including diverse annotation types in the loss function for pseudo-label filtering L_{PLF} improves the semantic image segmentation accuracy over a baseline shown in the last row of the table, which exclusively relies on pixel wise annotations and was trained using a cross entropy loss function L_{CE}. The remaining rows of the first (upper) section indicate that adding the loss function L_{DSP} improves the semantic image segmentation accuracy, confirming an increased accuracy due the use of annotation type dependent loss functions. The second section shows that the temperature τ=0.005 yields best results. The third section shows that using five characteristic elements |P_{c}=5| for each class yields more accurate results compared to 1 or 10 characteristic elements. Finally, the fourth section indicates that a supervised training using only complete pixel level annotations 16 or positive partial pixel level annotations 18 and a cross entropy loss function L_{CE} yields suboptimal results.

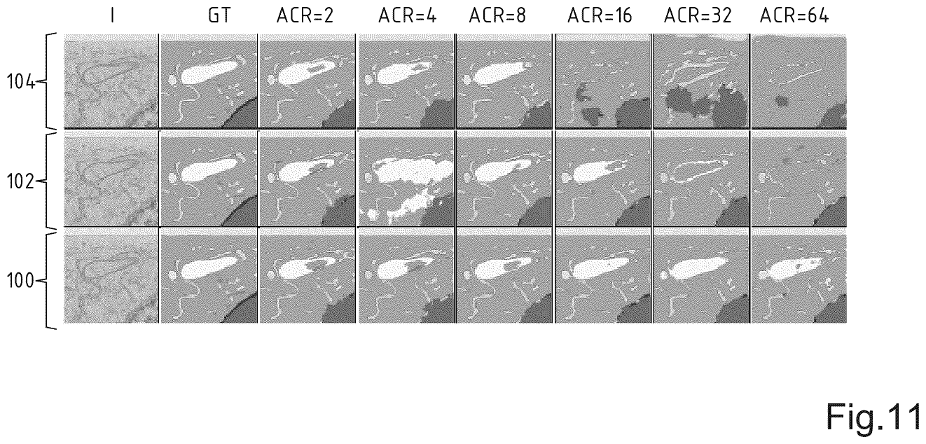

FIG. 11 shows qualitative results on an image from the HELA-2 dataset comprising five different class labels. The first row shows results for the basic Unet machine learning model 104, the second row for the second machine learning model 102 and the third row for the first machine learning model 100. The first column on the left shows the image I from the HELA-2 dataset, the second column the ground truth segmentation GT, and the remaining columns show the semantic image segmentation results for increasing ACRs between 2 and 64. The accuracy of the segmentation of the basic Unet machine learning model 104 already declines for low ACRs of 2 or 4, while the accuracy of the segmentation of the second machine learning model 102 is acceptable up to an ACR of 16. In contrast, the first machine learning model 100 can still segment the organelles at ACRs of 32 or 64.

The methods disclosed herein for training a machine learning model for semantic image segmentation and the methods for semantic image segmentation that use a machine learning model trained according to the training methods above can be used in various applications.

In an example, the methods disclosed herein can be used in fluorescence or brightfield microscopy applications. To this end, the training images contain fluorescence or brightfield microscopy images. The annotations indicate, for example, cells, cell nuclei, cell walls, etc. The semantic image segmentation is used for segmenting cells, cell nuclei, cell walls, etc. in a fluorescence or brightfield microscopy image. The semantic segmentation can be used to monitor the growth of cells in a cell culture over time, e.g., to adapt curation parameters such as temperature or humidity.

A method for semantic image segmentation in a fluorescence or brightfield microscopy image comprises: acquiring a fluorescence or brightfield microscopy image 94; and applying the machine learning model 28 trained using a method according to the first embodiment of the invention to the acquired fluorescence or brightfield microscopy image 94 to obtain a semantic image segmentation 30 of the acquired fluorescence or brightfield microscopy image 94. The method for semantic image segmentation can, for example, be used to monitor the growth of cells in a cell culture over time, e.g., to adapt curation parameters such as temperature or humidity.

In some embodiments, the images used for training the machine learning model may be acquired using dedicated imaging hardware, such as fluorescence or brightfield microscopes, optionally equipped with automated scanning stages, interchangeable objectives of varying magnification, and image sensors including CCD or CMOS detectors. In further embodiments, other image acquisition modalities may be employed, such as X-ray imaging systems, magnetic resonance imaging systems, ultrasound devices, optical coherence tomography scanners, digital photography setups, etc. The fluorescence or brightfield microscopy image that is subjected to analysis may be obtained using the same or a separate imaging device configured to capture the cell culture under laboratory conditions, optionally in conjunction with environmental control units for regulating parameters such as temperature, humidity, or gas composition.

The acquired image may then undergo semantic image segmentation, wherein image regions corresponding to cells, cell clusters, or other relevant biological structures are identified and distinguished from background regions. The resulting segmentation data may be processed to extract quantitative measures of cell growth, such as confluence, density, morphology, or proliferation rates, and may also be employed to detect abnormal developments in the culture. By evaluating these parameters over time, the system can monitor the growth of cells in the culture and provide feedback to adapt curation parameters, such as temperature, humidity, nutrient supply, or illumination conditions. In embodiments employing non-microscopy image acquisition, the segmentation output may similarly be used to monitor features of interest in other biological or non-biological samples and to control corresponding process parameters in real time.

In an example, the methods disclosed herein can be used in medical applications, in particular for examining a patient's eyes. To this end, the training images contain OCT images. The annotations indicate, for example, the presence of sub-retinal fluids, etc. The semantic image segmentation can be used for segmenting sub-retinal fluids. Optionally, the volume of the sub-retinal fluids can be measured. Optionally, a warning can be issued in case a threshold of the volume is exceeded.

A method for semantic image segmentation in an OCT image comprises: acquiring an OCT image 94; and applying the machine learning model 28 trained using a method according to the first embodiment of the invention to the acquired OCT image 94 to obtain a semantic image segmentation 30 of the OCT image 94. The method for semantic image segmentation can, for example, be used to measure the volume of sub-retinal fluids. The volume of the sub-retinal fluids may be compared with a predetermined threshold level. A warning can, optionally, be issued in case the volume of the sub-retinal fluids exceeds the predetermined threshold level.

In some embodiments, the images used for training the machine learning model for segmenting sub-retinal fluids may be acquired using optical coherence tomography (OCT) hardware. Suitable devices include spectral-domain OCT scanners and swept-source OCT scanners, which comprise scanning optics, interferometric detection modules, and digital image acquisition components such as CCD or CMOS sensors. The OCT image subjected to subsequent analysis may likewise be obtained with such an OCT device, optionally of the same or a different type, configured to provide high-resolution cross-sectional or volumetric images of the retina of a patient.

To obtain annotations for training the machine learning model, a user interface may be provided that allows interaction with an expert, such as a clinician or ophthalmologist. The interface may display the OCT images and offer input tools, for example drawing tools, contour markers, text input tools, or region-of-interest selectors, which enable the expert to indicate regions corresponding to sub-retinal fluids using at least three different annotation types. Drawing tools may, for example, be useful to indicate complete or partial pixel-level annotations. Region-of-interest selectors may be useful to indicate subset-level annotations such as bounding boxes. Text input tools may be useful to indicate image-level annotations. The annotations provided via the user interface can then be stored and used as ground truth data to supervise training of the machine learning model.

During operation, semantic image segmentation may be applied to OCT images to automatically identify and delineate sub-retinal fluids within the retinal layers. The segmentation output can be processed to extract quantitative parameters, including the extent, thickness, and morphology of the segmented regions. Furthermore, by integrating segmented cross-sectional areas across multiple OCT slices, the system can determine the volume of sub-retinal fluids. The resulting volumetric measurements enable objective monitoring of disease progression and assessment of treatment efficacy over time.

In an example, the methods can be used for quality control or process control, e.g., in an image such as an RGB, Xray, SEM or CT image. To this end, the training images contain images of objects such as building components, specimens, photolithography masks, wafers, etc. The annotations indicate, for example, defects or specific features of the objects such as cracks, scratches, porosities, pores, voids, adhesive surfaces, battery parts, solder joints, welding seams, etc. The semantic image segmentation can be used for segmenting defects or specific features of the objects. Optionally, measurements of the objects such as dimensions, size, area, volume, orientation, etc., can be derived from the semantic image segmentation, e.g., to evaluate the quality of the objects.

A method for semantic image segmentation in an image comprises: acquiring an image 94 of an object; and applying the machine learning model 28 trained using a method according to the first embodiment of the invention to the acquired image 94 to obtain a semantic image segmentation 30 of the image 94. The method for semantic image segmentation can, for example, be used to take measurements of the object and/or to evaluate the quality of the object and/or to take a decision on repairing the object and/or on marking the object as scrap, etc.

In some embodiments, the training images used for developing the machine learning model may be acquired using imaging hardware such as optical microscopes, scanning electron microscopes, X-ray imaging systems, CT imaging systems, or other inspection devices configured for high-resolution imaging of manufactured objects, for example automotive parts, wafers or photolithography masks. The image to which the trained machine learning model is subsequently applied may be obtained with the same or a different imaging system, optionally integrated into a manufacturing line for in-line inspection. To generate annotations for training, a user interface may be provided that enables interaction with an expert, such as a process engineer or quality-control specialist, who may mark regions corresponding to defects or specific features of the objects directly on displayed images using input tools such as drawing instruments, contour markers, region-of-interest selectors, text input tools, or region selectors. Drawing instruments may, for example, be useful to indicate complete or partial pixel-level annotations. Contour markers or region-of-interest selectors may be useful to indicate subset-level annotations such as bounding boxes. Text input tools may be useful to indicate image-level annotations. Using such diverse input tools, at least three different annotation types may be provided for a set of training images by the process engineer or quality-control specialist. Once trained, the machine learning model may be applied to perform semantic image segmentation, wherein defects (e.g., porosity, cracks, inclusions in automotive parts or scratches, bridging, voids in wafers or photolithography masks, etc.) or relevant structural features (e.g., alignment marks, critical dimensions in photolithography masks) are automatically identified and delineated. From the segmented regions, measurements such as dimensions, size, area, volume, or orientation of the objects or their features or defects can be derived, or statistics thereon. These measurements may be employed to evaluate the quality of the objects by comparing them to predefined tolerance thresholds. Based on this evaluation, automated or semi-automated decisions may be taken, for example whether the object requires repair or rework, or whether the object should be marked as scrap and removed from the production flow.

In some embodiments, a system may be provided for identifying defects in a photolithography mask using a machine learning model trained on training images of photomasks. The training images may collectively comprise at least three different types of annotations, for example positive partial pixel-level annotations and subset level annotations (e.g., bounding boxes) covering different defects and positive image level annotations indicating the type of defect. Drawing tools may, for example, be useful to indicate complete or partial pixel-level annotations by marking the pixels belonging to defects. Region-of-interest selectors may be useful to indicate subset-level annotations such as bounding boxes containing defects. Text input tools may be useful to indicate image-level annotations such as defect types, e.g., bridges, edge rounding, line edge roughness, particle contamination, etc. The machine learning model may be configured to process images of photomasks obtained using optical, electron, or other high-resolution imaging systems and to perform semantic image segmentation to automatically detect and delineate defects. Once defects are identified, the system may further be configured to perform corrective actions, such as directing repair processes on the mask, generating instructions for manual or automated repair equipment, or marking the mask for rework, scrap or further inspection. The combination of multi-type annotated training data and automated defect identification enables improved detection accuracy, efficient repair workflows, and enhanced quality control in photolithography mask manufacturing.

In some embodiments, a system may be provided for detecting diseases in biological samples using a machine learning model trained on training images of biological samples. The training images may collectively comprise at least three different types of annotations, for example positive partial pixel-level annotations and subset level annotations (e.g., bounding boxes) covering structures of interest such as different disease markers, tissue structures or pathological features and positive image level annotations indicating the type of the structure of interest or of a corresponding disease. Drawing tools may, for example, be useful to indicate complete or partial pixel-level annotations by marking the pixels belonging to structures of interest. Region-of-interest selectors may be useful to indicate subset-level annotations such as bounding boxes containing structures of interest. Text input tools may be useful to indicate image-level annotations such as types of the structures of interest or diseases, etc. The machine learning model may be configured to process images obtained from imaging modalities such as brightfield or fluorescence microscopy, optical coherence tomography, or other high-resolution imaging systems, and to perform semantic image segmentation to automatically identify regions corresponding to disease-relevant features. Upon detection of one or more disease indicators in a sample, the system may generate alerts or notifications to inform a user, such as a clinician or laboratory technician, of the potential presence of disease. The combination of multi-type annotated training data and automated detection enables accurate disease identification, efficient monitoring of biological samples, and timely intervention or follow-up actions.

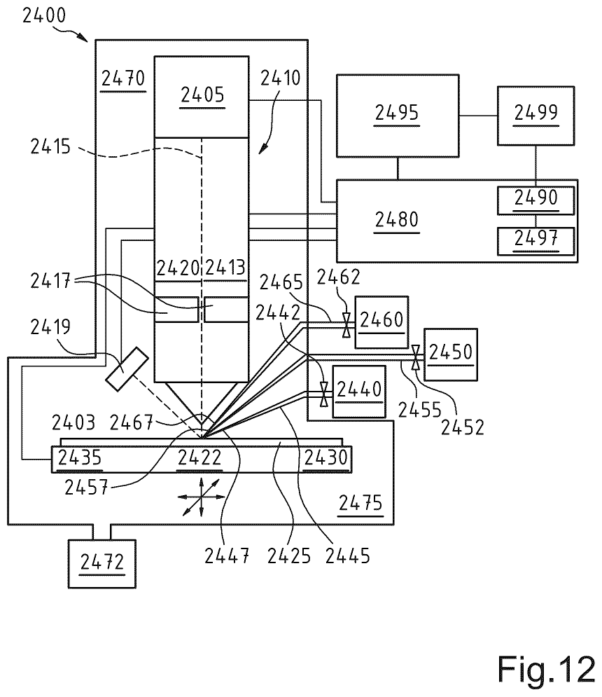

FIG. 12 illustrates a schematic section through an apparatus 2400 which can perform a method for semantic image segmentation according to the invention and a local chemical sample repair process. The sample can, for example, refer to a photomask. The exemplary apparatus 2400 comprises a modified scanning particle microscope 2410 in the form of a scanning electron microscope (SEM). The apparatus includes an electron beam source 2405 that generates an electron beam 2415. The electron beam can be focused to a spot diameter in the nanometer range, significantly smaller than the focus diameter of a photon beam, thereby providing high lateral resolution.

Compared with an ion beam, the electron beam 2415 has the advantage that it causes substantially no damage to the sample 2425. Alternatively, an ion beam, atomic beam, or molecular beam may also be employed in the apparatus 2400.

The scanning particle microscope 2410 comprises the electron beam source 2405 and a column 2420 containing a beam optical unit 2413. The electron beam is directed and focused onto the sample 2425 at a location 2422 by the imaging elements in the column 2420. These imaging elements allow scanning of the beam across the sample.

Backscattered and secondary electrons generated by interaction of the beam with the sample are detected by an in-lens detector 2417 arranged in the column 2420. The detector converts the detected electrons into measurement signals, which are analyzed by an evaluation unit 2480 to generate an image of the sample. The image can be displayed on a display 2495. The apparatus 2400 may further comprise a second detector 2419 for detecting electromagnetic radiation, in particular X-rays, thereby allowing analysis of material composition. A third detector, such as an Everhart-Thornley detector, may also be provided outside the column 2420 for detecting secondary electrons.

The sample 2425 is arranged on a movable sample stage 2430, which can be translated in three directions and rotated about one or more axes. The SEM 2410 is operated within a vacuum chamber 2470, maintained at reduced pressure by a pump system 2472.

The apparatus 2400 may perform particle beam induced deposition (EBID) and particle beam induced etching (EBIE). For this purpose, three supply containers 2440, 2450, and 2460 are provided for storing precursor and etching gases. The first supply container 2440 stores a precursor gas, which can be locally decomposed by the electron beam 2415 to deposit material on the sample 2425. The second supply container 2450 stores an etching gas, which can be used for localized removal of material by EBIE. By way of example, an etching gas can comprise xenon difluoride (XeF2), a halogen or nitrosyl chloride (NOCl). The third supply container 2460 can store an additional precursor or etching gas, or a gas that can be added to the first or second gas.

Each supply container 2440, 2450, 2460 has its own control valve 2442, 2452, 2462 to regulate the gas flow to the point of incidence 2422 of the electron beam on the sample. Each container also has a dedicated gas feedline 2445, 2455, 2465 ending in a nozzle 2447, 2457, 2467 positioned near the point of incidence. The containers may further include temperature control elements to maintain optimal gas conditions.

The apparatus 2400 can include multiple precursor or etching gas containers, enabling a variety of EBID and EBIE processes.

The evaluation unit 2480 may comprise a processor 2490 and a memory 2497. The apparatus 2400 further includes a user interface 2499. The user interface 2499 may be configured to display images using the display evaluation unit 2495 and to let a user provide at least three types of annotations in the images. The annotations may be provided using different annotation tools as illustrated further below, e.g., drawing tools, contour markers, text input tools, or region-of-interest selectors, etc. Drawing tools may, for example, be useful to indicate complete or partial pixel-level annotations. Region-of-interest selectors may be useful to indicate subset-level annotations such as bounding boxes. Text input tools may be useful to indicate image-level annotations. The annotations provided via the user interface 2499 can then be stored in the memory 2497 and used as ground truth data to supervise training of the machine learning model for semantic image segmentation, in particular for defect detection, using a processor 2490. The trained machine learning model for defect segmentation may be stored in memory 2497 and applied to acquired images obtained by the evaluation unit 2480. The memory may contain instructions of the computer implemented method for training a machine learning model for defect segmentation and instructions of a computer implemented method for defect segmentation comprising applying the trained machine learning model to acquired images. Detected defects on the sample 2425 may be repaired using the repair processes described above.

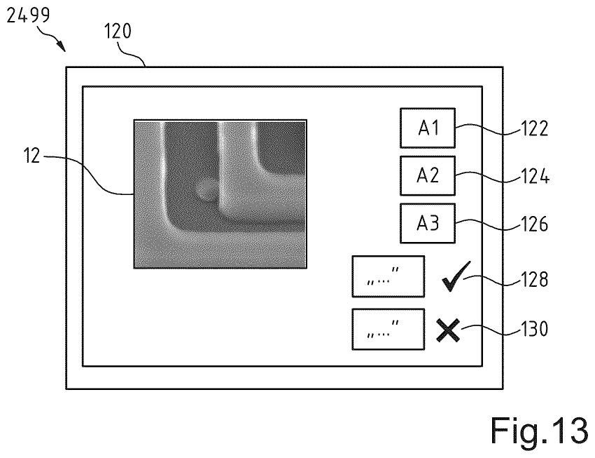

FIG. 13 illustrates details of the user interface 2499 of FIG. 12 for displaying and annotating images 12. A training image 12 of a photomask is displayed to a user on a display 120. Different annotation tools 122, 124, 126, 128, 130 are displayed, e.g., drawing tools 122, 124, region-of-interest selectors 126 or text input tools 128, 130. The drawing tools 122, 124 may be used for complete pixel level annotations and for positive or negative partial pixel level annotations. The region-of-interest selectors 126 may be used to indicate subset level annotations such as bounding boxes. The text input tools 128, 130 may be used to indicate positive image level annotations 128 or negative image level annotations 130, e.g., by entering a class name “C1” or “C2”. The user may be free to select different annotation tools for providing different annotation types. Proposals for further annotations or annotation types may be shown on the display. The user may also be guided through the annotation process by showing how many different annotation types have already been used in the images and which ones could be used next until at least three different annotation types have been used. The user interface may prompt the user to add a different annotation type or to select one out of the annotation types that have not been used so far to achieve at least three different annotation types in the training images.

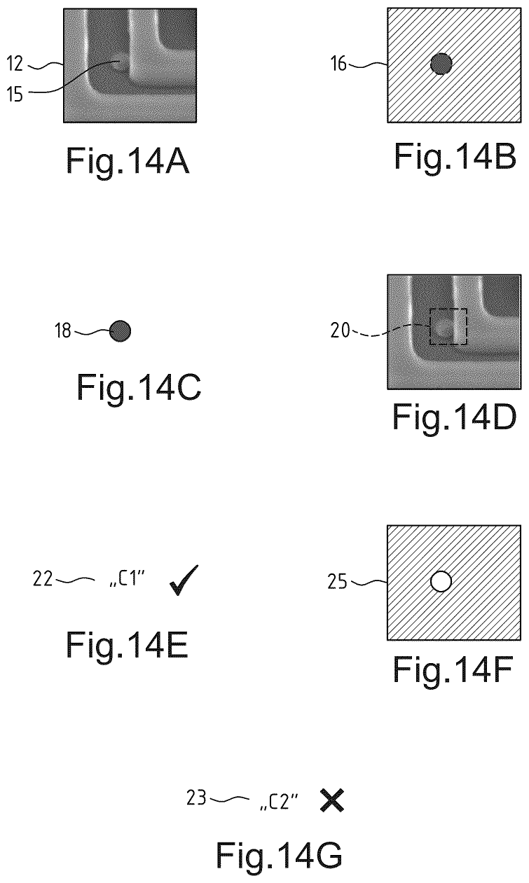

FIGS. 14A-14G show different annotation types for a training image 12 of a photomask comprising a contamination defect. FIG. 14A shows the training image 12 of the photomask as acquired by an imaging system, e.g., the system described in FIG. 12. The training image 12 contains a defect 15 in the form of a particle contamination. FIG. 14B shows a complete pixel level annotation 16 comprising a contamination defect class and a no-contamination defect class. FIG. 14C shows a positive partial pixel level annotation 18 comprising only the contamination defect class. FIG. 14D shows a subset level annotation 20 comprising a bounding box encompassing the contamination defect. FIG. 14E comprises a positive image level annotation 22 for the class “C1”, e.g., for a “defective” class. FIG. 14F comprises a negative partial pixel level annotation 25 for the contamination defect class indicating that the region does not contain a pixel belonging to a contamination defect. FIG. 14G comprises a negative image level annotation 23 for the class “C2”, e.g., for the bridge defect class, indicating that no bridge defect is present in the training image 12.

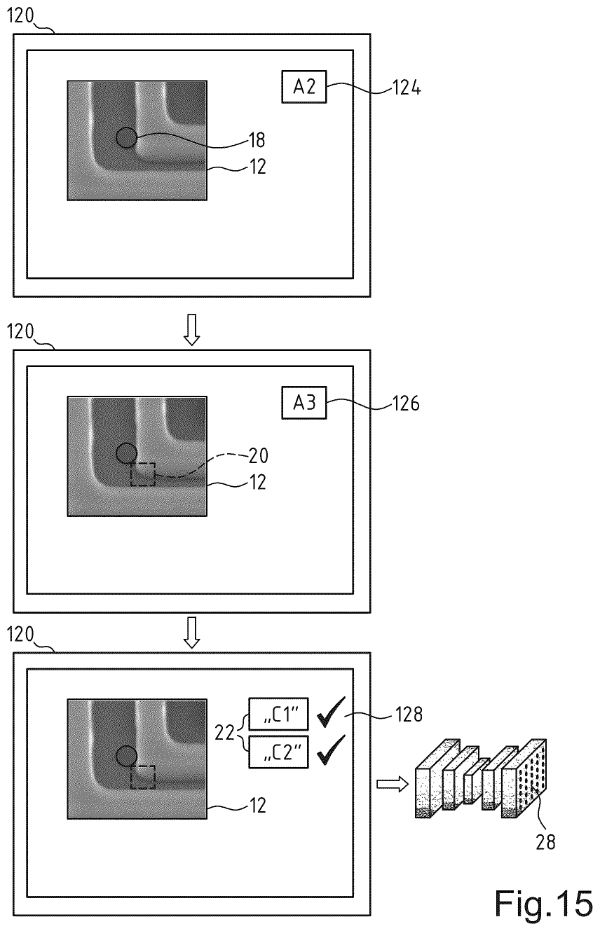

FIG. 15 illustrates an annotation process of a single training image 12 of a photomask comprising a contamination defect using three different annotation types. The three different annotation types can be used in a single image as shown here, or different annotation types may be used in different images of a training image set. In a first step the training image is displayed on the display and the contamination defect is annotated using a positive partial pixel level annotation 18. To this end, a drawing tool A2 is used. In a second step a corner rounding defect is annotated using a subset level annotation 20. To this end, a bounding box is added to the annotations using a region of interest selector 126. In a third step, a positive image level annotation 22 is provided by indicating a class of the contamination defect, e.g., C1=“contamination defect”. This step may be repeated to add a positive image level annotation 22 for the corner rounding defect, e.g., C2=“corner rounding”. A plurality of annotated training images is then used for training the machine learning model for semantic image segmentation 28.

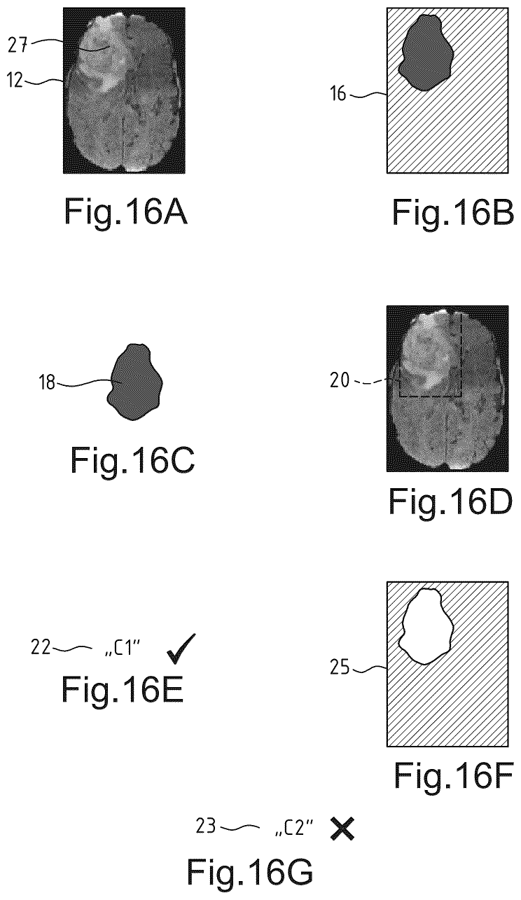

FIGS. 16A-16G show different annotation types for a medical training image 12 comprising a tumor 27. FIG. 16A shows the medical training image 12 as acquired by an imaging system, e.g., a magnet resonance imaging (MRI) scanner. FIG. 16B shows a complete pixel level annotation 16 comprising a tumor class and a no-tumor class. FIG. 16C shows a positive partial pixel level annotation 18 comprising only the tumor class. FIG. 16D shows a subset level annotation 20 comprising a bounding box encompassing the tumor. FIG. 16E comprises a positive image level annotation 22 for the class “C1”, e.g., for a “diseased” class. FIG. 16F comprises a negative partial pixel level annotation 25 for the tumor class indicating that the region does not contain a pixel belonging to a tumor. FIG. 16G comprises a negative image level annotation 23 for the class “C2”, e.g., for a “hemorrhage” class, indicating that bleeding outside the tumor occurred.

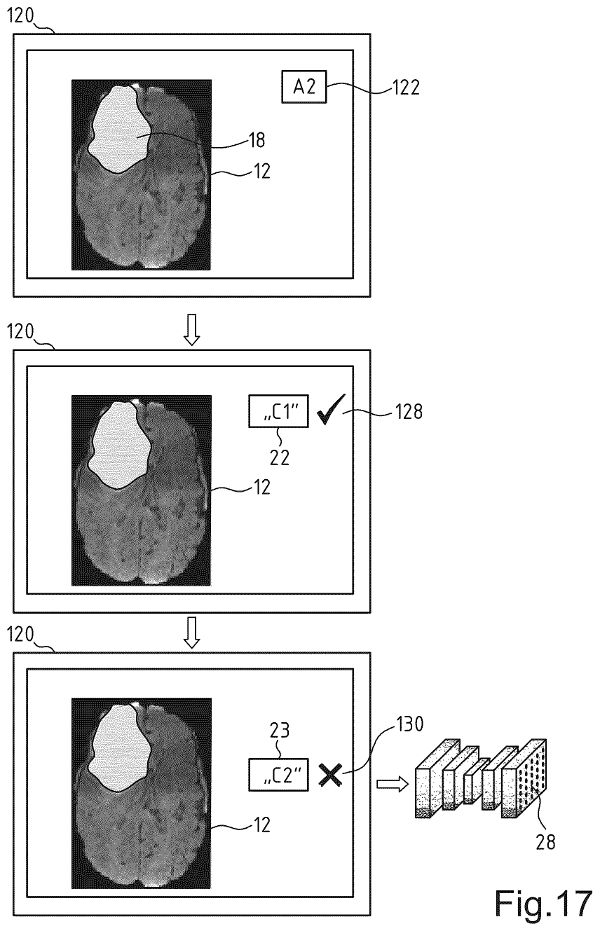

FIG. 17 illustrates an annotation process of a single training image 12 of an MRI image comprising a tumor using three different annotation types. The at least three different annotation types may be used in a single image as shown here, but different images of the training image set may also contain only a subset of the at least three annotation types. In a first step the training image is displayed on the display and the tumor is annotated using a positive partial pixel level annotation 18. To this end, a drawing tool A2 is used. In a second step a positive image level annotation 22 is provided by indicating a class, e.g., C1=“diseased”. In a third step, a negative image level annotation 23 may be added indicating C2=“no hemorrhage”. A plurality of annotated training images is then used for training the machine learning model for semantic image segmentation 28.

In some implementations, the data processing apparatus 76 can include one or more computers, each including one or more data processors for processing data, one or more storage devices for storing data, and/or one or more computer programs including instructions that when executed by the one or more computers cause the one or more computers to carry out the processes described above. The one or more computers can include one or more input devices, such as a keyboard, a mouse, a touchpad, and/or a voice command input module, and one or more output devices, such as a display, and/or an audio speaker.

In some implementations, the one or more computers can include digital electronic circuitry, computer hardware, firmware, software, or any combination of the above. The features related to processing of data can be implemented in a computer program product tangibly embodied in an information carrier, e.g., in a machine-readable storage device, for execution by a programmable processor; and method steps can be performed by a programmable processor executing a program of instructions to perform functions of the described implementations. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

A computer program can be written in any form of programming language, including compiled or interpreted languages, and it can be deployed in any form, including as a stand-alone program or as a module, component, subroutine, or other unit suitable for use in a computing environment.

For example, the one or more computers can be configured to be suitable for the execution of a computer program and can include, by way of example, both general and special purpose microprocessors, and any one or more processors of any kind of digital computer. Generally, a processor will receive instructions and data from a read-only storage area or a random access storage area or both. Elements of a computer system include one or more processors for executing instructions and one or more storage area devices for storing instructions and data. Generally, a computer system will also include, or be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor, at least one data storage system (including volatile and non-volatile memory and/or storage elements), at least one wired or wireless input device or port, and at least one wired or wireless output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment,” “according to an example” or “according to an aspect” in various places throughout this specification are not necessarily all referring to the same embodiment, example or aspect, but may refer to different embodiments. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

The invention can be described by the following clauses:
1. A computer implemented method 10 for training a machine learning model 28 for semantic image segmentation, the method comprising:
   Obtaining training images 12 containing collectively at least three different types of annotations 24, each annotation 24 comprising one or more pixels of a training image 12 and an indicated class label, the types of annotations 24 being from a group comprising
      Complete pixel level annotations 16 comprising all pixels of the training image 12 that are assigned to the indicated class, in case the training image 12 is fully labeled,
      Positive partial pixel level annotations 18 comprising a portion of the pixels of the training image 12 that are assigned to the indicated class,
      Subset level annotations 20 comprising a subset of the training image 12, such that a portion of the pixels within the subset is assigned to the indicated class,
      Positive image level annotations 22 comprising the training image 12, wherein a portion of the pixels of the training image 12 is assigned to the indicated class;
      Negative partial pixel level annotations 19 comprising a portion of the pixels of the training image 12 that are not assigned to the indicated class,
      Negative image level annotations 22 comprising the training image 12, wherein none of the pixels of the training image 12 is assigned to the indicated class;
   Training the machine learning model 28 by iteratively presenting a batch of training images 12 to the machine learning model 28 and modifying the parameters of the machine learning model 28 using a loss function, wherein the formulation of the loss function at at least one pixel depends on the types of annotations 24 at the pixel and on the types of annotations 24 within the batch, for the purpose of using the trained machine learning model 28 for semantic image segmentation 30.
2. The method of clause 1, wherein the group consists of complete pixel level annotations 16, positive partial pixel level annotations 18, subset level annotations 20, positive image level annotations 22, negative partial pixel level annotations and negative image level annotations 23.
3. The method of clause 1, wherein the group consists of complete pixel level annotations 16, positive partial pixel level annotations 18, subset level annotations 20, and positive image level annotations 22.
4. The method of any one of the preceding clauses, wherein the at least three types of annotations 24 comprise complete pixel level annotations 16 or positive partial pixel level annotations 18.
5. The method of clause 4, wherein the at least three types of annotations 24 comprise positive image level annotations 22.
6. The method of any one of the preceding clauses, wherein the iteratively presented batches of training images 12 are configured such that for each type of annotation 24 a training image 12 exists, such that all other types of the at least three different types of annotations 24 are contained in at least one training image 12 of the preceding training images 12.
7. The method of any one of the preceding clauses, wherein the loss function comprises a contrastive loss function for semantic image segmentation.
8. The method of clause 7, wherein the contrastive loss function is configured such that the association 46 of the pixels of an annotation 24 to the class indicated by the annotation 24 is encouraged, while the associations 46 of pixels outside the annotation 24 to a class are attenuated if the class is different from the class indicated by the annotation 24 or if the class is equal to the class indicated by the annotation 24 but incompatible with the annotations 24 at the pixels outside the annotation 24.
9. The method of clause 8, wherein the way the association 46 of the pixels of an annotation 24 to the class indicated by the annotation 24 is encouraged depends on the type of the annotation 24.
10. The method of clause 8 or 9, wherein the association 46 of the pixels of an annotation 24 to the class indicated by the annotation 24 is weighted by a weighting factor depending on the type of the annotation 24.
11. The method of any one of clauses 8 to 10, wherein the machine learning model 28 maps each pixel of an input image 26 to an embedding vector 44 of the pixel in a feature space 40, and wherein the association 46 of a pixel to a class is measured in this feature space 40.
12. The method of any one of clauses 8 to 11, wherein the association 46 of a pixel to a class is measured by the similarity of an embedding vector 44 of the pixel in a feature space 40 and one or more characteristic elements 42 of the class in the feature space 40.
13. The method of clause 12, wherein the characteristic elements 42 of each class belong to the parameters of the machine learning model 28, which are optimized by minimizing the loss function during the iterations of the training.
14. The method of any one of the preceding clauses, further comprising using augmented training images 60 with pseudo-annotations 62 during training of the machine learning model 28, wherein the augmented training images 60 are generated by modifying training images 12, and wherein the pseudo-annotations 62 are generated by presenting the augmented training images 60 to the machine learning model 28 and obtaining class labels, and wherein the loss function is configured to filter the pseudo-annotations 62 by preventing the association 46 of a pixel in an augmented training image 60 to the class indicated by the pseudo-annotation 62 at that pixel if the pseudo-annotation 62 is not compatible with an annotation 24 at the corresponding pixel in the training image annotation 24.
15. The method of clause 14, wherein the augmented training images 60 are obtained by applying one or more image processing operations from the group comprising flipping, rotation, translation, contrast variation, brightness variation, saturation variation and hue variation to the training images 12, and wherein for each augmented training image 60 one or more strongly augmented training images 64 are obtained by applying one or more arbitrary image processing operations to the corresponding training image 12, and wherein the loss function is configured to filter the pseudo-annotations 62 of the augmented training images 60 and to measure the deviation of the machine learning model class associations 46 on the strongly augmented training images 64 from the filtered pseudo-annotations 66 of the corresponding augmented training images 60.
16. The method of any one of the preceding clauses, further comprising retraining the machine learning model 28 on a subset of the training images 12 with annotations 24 of increased specificity, wherein the specificity of a positive image level annotation 22 in a training image 12 is increased by adding one or more subset level annotations 20 or one or more complete pixel level annotations 16 or one or more positive partial pixel level annotations 18 with the same class label to the training image 12, and wherein the specificity of a subset level annotation 20 in a training image 12 is increased by adding one or more positive partial pixel level annotations 18 with the same class label within the subset in the training image 12.
17. A computer implemented method 70 for semantic image segmentation, the method comprising obtaining an image 94 and applying the machine learning model 28 trained according to any one of the preceding clauses to the obtained image 94 to obtain a semantic image segmentation 30.
18. A data processing apparatus 76, which is configured for carrying out a method of any one of clauses 1 to 16.
19. A system 84 for semantic image segmentation comprising
   an imaging device 90 configured to provide an image 94 of a scene 92;
   one or more processing devices 80;
   one or more machine-readable hardware storage devices 82 comprising a machine learning model 28 trained using a method of any one of clauses 1 to 16 and comprising instructions that are executable by one or more processing devices 80 to apply the trained machine learning model 28 to the image 94 of the scene 92.
20. A computer program comprising instructions which, when the program is executed by a computer, cause the computer to carry out a method of any one of clauses 1 to 17.
21. A computer-readable medium, on which a computer program executable by a computing device is stored, the computer program comprising code for executing a method of any one of clauses 1 to 17.
22. The method of any one of clauses 1 to 16, comprising using an image acquisition device to obtain training images;
   using a graphical user interface to provide the training images to an expert;
   using the graphical user interface to receive three or more types of annotations from the expert; and
   storing the training images and associated annotations in a storage device.
23. The method of clause 22, wherein the graphical user interface comprises a display configured to display training images to a user and annotation tools configured for enabling the user to provide annotations of at least three different annotation types.
24. A system for detecting defects in a photomask comprising:
   an imaging device configured to provide an image of the photomask;
   one or more processing devices; and
   one or more machine-readable hardware storage devices storing a machine learning model for semantic image segmentation, the machine learning model being trained using annotated training images of photomasks, wherein the annotated training images collectively include at least three different annotation types, and wherein the hardware storage devices further store instructions executable by the processing devices to apply the trained machine learning model to the acquired image of the photomask to detect defects.
25. The system of clause 24, wherein the machine learning model for semantic image segmentation is trained according to the method of clause 1.
26. The system of clause 24 or 25, wherein the machine learning model for semantic image segmentation is configured to detect defects in the image of the photomask.
27. The system of clause 26, further comprising instructions executable by the processing devices to generate repair instructions based on the detected defects, and wherein the system is configured to repair the photomask according to the repair instructions.
28. The system of clause 26, wherein, depending on the detected defects, the photomask is discarded.
29. A system for detecting diseases in a biological sample comprising:
   an imaging device configured to provide an image of the biological sample;
   one or more processing devices; and
   one or more machine-readable hardware storage devices storing a machine learning model for semantic image segmentation, the machine learning model being trained using annotated training images of biological samples, wherein the annotated training images collectively include at least three different annotation types, and wherein the hardware storage devices further store instructions executable by the processing devices to apply the trained machine learning model to the acquired image of the biological sample to detect diseases.
30. The system of clause 29, wherein the machine learning model for semantic image segmentation is trained according to the method of clause 1.
31. The system of clause 29 or 30, wherein the machine learning model for semantic image segmentation is configured to detect disease markers in the image of the biological sample.
32. The system of clause 31, further comprising instructions executable by the processing devices to generate alerts in case of a detected disease.
33. A user interface for obtaining expert annotations of images, comprising:
   a display configured to present a set images to an expert; and
   one or more processing devices coupled to the display and configured to:
      provide one or more controls to the expert for annotating the image; and
      prompt the expert to provide at least three different types of annotations collectively on the set of images.
34. The user interface of clause 33, wherein the types of annotations are from a group comprising:
   complete pixel level annotations comprising all pixels of the training image that are assigned to the indicated class, in case the training image is fully labeled,
   positive partial pixel level annotations comprising a portion of the pixels of the training image that are assigned to the indicated class,
   subset level annotations comprising a subset of the training image, such that a portion of the pixels within the subset is assigned to the indicated class,
   positive image level annotations comprising the training image, wherein a portion of the pixels of the training image is assigned to the indicated class;
   negative partial pixel level annotations comprising a portion of the pixels of the training image that are not assigned to the indicated class, and
   negative image level annotations comprising the training image, wherein none of the pixels of the training image is assigned to the indicated class.
35. The user interface of clause 33 or 34, wherein the one or more processing devices are further configured to record the annotations in a format suitable for training a machine learning model.

The invention described by examples and embodiments is however not limited to the clauses but can be implemented by those skilled in the art by various combinations or modifications.

In a general aspect, the invention relates to a computer implemented method 10 for training a machine learning model 28 for semantic image segmentation 30, the method comprising: obtaining training images 12 containing collectively at least three different types of annotations 24, and training a machine learning model 28, wherein the formulation of the loss function at at least one pixel depends on the types of annotations 24 at the pixel and on the types of annotations 24 within each batch. The invention also relates to a computer implemented method for semantic segmentation making use of the trained machine learning model, and to corresponding systems, computer programs and computer readable media.

### REFERENCE NUMBER LIST

10 Computer implemented method
12 Training images
13 Fully labeled training image
14 Expert annotators
15 Defect
16 Complete pixel level annotation
18 Positive partial pixel level annotation
20 Subset level annotation
22 Positive image level annotation
23 Negative image level annotation
24 Annotation
25 Negative partial pixel level annotation
26 Input image
27 Tumor
28 Machine learning model
30 Semantic image segmentation
32 Unannotated training image
33 Training image providing step
34 Training image step
35 Annotation step
36 Loss function step
37 Storing step
38 Training step
39 Forward pass step
40 Feature space
41 Update step
42 Characteristic element
44 Embedding vector
46 Association
48 Second row
50 Third row
52 Fourth row
54 First class
56 Second class
58 Third class
60 Augmented training image
62 Pseudo-annotation
64 Strongly augmented training image
66 Filtered pseudo-annotation
68 Transferred filtered pseudo-annotation
70 Computer implemented method
72 Imaging step
74 Machine learning model application step
76 Data processing apparatus
78 Training unit
80 Processing device
82 Hardware-storage device
84 System
86 Memory
88 Interface
90 Imaging device
92 Scene
94 Image
96 Vertical axis
98 Horizontal axis
100 First machine learning model
102 Second machine learning model
104 UNet machine learning model
120 Display
122, 124 Drawing tools
126 Region-of-interest selector
128, 130 Text input tool
2400 Apparatus
2405 Electron beam source
2410 Scanning particle microscope
2413 Beam optical unit
2415 Electron beam
2417 First detector (“in lens detector”)
2419 Second detector (X-ray detector)
2420 Column of SEM
2422 Location
2425 Sample
2430 Sample stage
2440 First supply container
2442 Control valve of first supply container
2445 Gas feedline of first supply container
2447 Nozzle of first supply container
2450 Second supply container (etching gas)
2452 Control valve of second supply container
2455 Gas feedline of second supply container
2457 Nozzle of second supply container
2460 Third supply container (additional/alternative gas)
2462 Control valve of third supply container
2465 Gas feedline of third supply container
2467 Nozzle of third supply container
2470 Vacuum chamber
2472 Pump system
2480 Evaluation unit
2490 Processor
2495 Display of evaluation unit
2497 Memory
2499 User interface

What is claimed is:

1. A computer implemented method for training a machine learning model for semantic image segmentation, the method comprising:
obtaining training images containing collectively at least three different types of annotations, each annotation comprising one or more pixels of a training image and an indicated class label, the types of annotations being from a group comprising
complete pixel level annotations comprising all pixels of the training image that are assigned to the indicated class, in case the training image is fully labeled,
positive partial pixel level annotations comprising a portion of the pixels of the training image that are assigned to the indicated class,
subset level annotations comprising a subset of the training image, such that a portion of the pixels within the subset is assigned to the indicated class,
positive image level annotations comprising the training image, wherein a portion of the pixels of the training image is assigned to the indicated class;
negative partial pixel level annotations comprising a portion of the pixels of the training image that are not assigned to the indicated class, and
negative image level annotations comprising the training image, wherein none of the pixels of the training image is assigned to the indicated class;
training the machine learning model by iteratively presenting a batch of training images to the machine learning model and modifying the parameters of the machine learning model using a loss function, wherein the formulation of the loss function at at least one pixel depends on the types of annotations at the pixel and on the types of annotations within the batch, for the purpose of using the trained machine learning model for semantic image segmentation.

2. The method of claim 1, wherein the group consists of complete pixel level annotations, positive partial pixel level annotations, subset level annotations, positive image level annotations, negative partial pixel level annotations and negative image level annotations.

3. The method of claim 1, wherein the group consists of complete pixel level annotations, positive partial pixel level annotations, subset level annotations, and positive image level annotations.

4. The method of claim 1, wherein the at least three types of annotations comprise complete pixel level annotations or positive partial pixel level annotations.

5. The method of claim 4, wherein the at least three types of annotations comprise positive image level annotations.

6. The method of claim 1, wherein the iteratively presented batches of training images are configured such that for each type of annotation a training image exists, such that all other types of the at least three different types of annotations are contained in at least one training image of the preceding training images.

7. The method of claim 1, wherein the loss function comprises a contrastive loss function used to learn a pixelwise mapping to a feature space for semantic image segmentation.

8. The method of claim 7, wherein the contrastive loss function is configured such that the association of the pixels of an annotation to the class indicated by the annotation is encouraged, while the associations of pixels outside the annotation to a class are attenuated if the class is different from the class indicated by the annotation or if the class is equal to the class indicated by the annotation but incompatible with the annotations at the pixels outside the annotation.

9. The method of claim 8, wherein the way the association of the pixels of an annotation to the class indicated by the annotation is encouraged depends on the type of the annotation.

10. The method of claim 8, wherein the association of the pixels of an annotation to the class indicated by the annotation is weighted by a weighting factor depending on the type of the annotation.

11. The method of claim 7, wherein the machine learning model maps each pixel of an input image to an embedding vector of the pixel in the feature space, and wherein the association of a pixel to a class is measured in this feature space.

12. The method of claim 7, wherein the association of a pixel to a class is measured by the similarity of an embedding vector of the pixel in the feature space and one or more characteristic elements of the class in the feature space.

13. The method of claim 7, wherein the association of a pixel to a class is measured using a function of the similarities of an embedding vector of the pixel in the feature space and two or more characteristic elements of the class in the feature space.

14. The method of claim 12, wherein the characteristic elements of each class belong to the parameters of the machine learning model, which are optimized by minimizing the loss function during the iterations of the training.

15. The method of claim 7, wherein the feature space is used to associate a pixel to a class.

16. The method of claim 7, wherein the pixelwise mapping to the feature space is configured to group embedding vectors of pixels of annotations with the same class label and to contrast embedding vectors of pixels of annotations with different class labels.

17. The method of claim 1, further comprising using augmented training images with pseudo-annotations during training of the machine learning model, wherein the augmented training images are generated by modifying training images, and wherein the pseudo-annotations are generated by presenting the augmented training images to the machine learning model and obtaining class labels, and wherein the loss function is configured to filter the pseudo-annotations by preventing the association of a pixel in an augmented training image to the class indicated by the pseudo-annotation at that pixel if the pseudo-annotation is not compatible with an annotation at the corresponding pixel in the training image annotation.

18. The method of claim 17, wherein the augmented training images are obtained by applying one or more image processing operations from the group comprising flipping, rotation, translation, contrast variation, brightness variation, saturation variation and hue variation to the training images, and wherein for each augmented training image one or more strongly augmented training images are obtained by applying one or more arbitrary image processing operations to the corresponding training image, and wherein the loss function is configured to filter the pseudo-annotations of the augmented training images and to measure the deviation of the machine learning model class associations on the strongly augmented training images from the filtered pseudo-annotations of the corresponding augmented training images.

19. The method of claim 1, further comprising retraining the machine learning model on a subset of the training images with annotations of increased specificity, wherein the specificity of a positive image level annotation in a training image is increased by adding one or more subset level annotations or one or more complete pixel level annotations or one or more positive partial pixel level annotations with the same class label to the training image, and wherein the specificity of a subset level annotation in a training image is increased by adding one or more positive partial pixel level annotations with the same class label within the subset in the training image.

20. The method of claim 1, wherein at least one training image contains at least two annotations of different types.

21. The method of claim 1, wherein at least one pixel of at least one training image belongs to at least two annotations of different types.

22. A computer implemented method for semantic image segmentation, the method comprising obtaining an image and applying the machine learning model trained according to claim 1 to the obtained image to obtain a semantic image segmentation.

23. A data processing apparatus, which is configured for carrying out a method of claim 1.

24. A system for semantic image segmentation comprising
an imaging device configured to provide an image of a scene;
one or more processing devices;
one or more machine-readable hardware storage devices comprising a machine learning model trained using a method of claim 1 and comprising instructions that are executable by one or more processing devices to apply the trained machine learning model to the image of the scene.

25. A computer program comprising instructions which, when the program is executed by a computer, cause the computer to carry out a method of claim 1.

26. A computer-readable medium, on which a computer program executable by a computing device is stored, the computer program comprising code for executing a method of claim 1.

27. A data carrier signal carrying the computer program of claim 25.
